(19) United States
(12) Patent Application Publication
(10) Pub. No.: US 2025/0382319 A1
(43) Pub. Date: Dec. 18, 2025

(54) ONE STEP SYNTHESIS OF HIGH PURITY PRECURSORS

(71) Applicant: ENTEGRIS, INC., Billerica, MA (US)

(72) Inventor: David Kuiper, Brookfield, CT (US)

(21) Appl. No.: 19/237,943

(22) Filed: Jun. 13, 2025

Related U.S. Application Data
(60) Provisional application No. 63/659,757, filed on Jun. 13, 2024.

(51) Int. Cl. C07F 11/00

(52) U.S. Cl. CPC C07F 11/005

(57) ABSTRACT

Methods for forming high purity metal complex precursors in a single step and related products are provided herein. The method includes obtaining a first reactant and obtaining a second reactant. The method includes contacting the first reactant and second reactant to form a reaction product. The reaction product is a metal complex precursor. The reaction product has a purity of 90% or greater as measured by gas chromatography-mass spectroscopy.

### CROSS-REFERENCE TO RELATED APPLICATIONS

This application claims the benefit under 35 USC 119 of U.S. Provisional Patent Application No. 63/659,757, filed Jun. 13, 2024, the disclosure of which is hereby incorporated herein by reference in its entirety.

### FIELD

The present disclosure relates to one step synthesis of high purity metal precursors containing 2,2,6,6-tetramethyl-3,5-heptanedione (THD) ligands.

### BACKGROUND

Currently, synthesis of high purity THD containing precursors involves multiple steps, such as a step for forming a first reactant, a step for forming a second reactant, and a step of reacting the first reactant and second reactant to form the THD containing precursor. However, multistep synthesis processes can be costly and time consuming.

### SUMMARY

Some embodiments relate to a method. In some embodiments, the method comprises obtaining a first reactant. In some embodiments, the first reactant comprises the formula: M(L¹)ₐ(L²)_{b}(L³)_{c}(L⁴)ₐ(A)ₑ. In some embodiments, M comprises at least one of chromium, molybdenum, tungsten, or any combination thereof. In some embodiments, each of L¹, L², L³, and L⁴ independently comprises at least one of an amine, a carbon monoxide, a carbonyl, a nitrile, an isonitrile, a thioalkyl, a sulfoxide, an ester, an alkoxy, a polyol, an anhydride, a heterocyclic, a phosphine, a guanidino, an amidino, an alkenyl, a cycloalkenyl, an alkynyl, a cycloalkynyl, an aryl, a dinitrogen, an aquo, a nitric oxide, a sulfonyl, or any combination thereof. In some embodiments, a is 0 to 6. In some embodiments, b is 0 to 6. In some embodiments, c is 0 to 6. In some embodiments, d is 0 to 6. In some embodiments, A comprises an anionic type ligand. In some embodiments, A comprises at least one of an alkyl, an allyl, an alkenyl, an alkynyl, a cycloalkyl, a cycloalkenyl, a cycloalkynyl, a haloalkyl, a halocycloalkyl, a hydride, an aryl, a hydrazino, a hydrazido, an imido, a halide, a triflate, a tosylate, a mesylate, an amido, an iminato, an amidinato, a β-diketiminato, β-diketonato, propiolamidinato, amidoximato, hydrazonato, a phosphide, or any combination thereof. In some embodiments, e is 0 to 6. In some embodiments, a+b+c+d+e is 1 to 8. In some embodiments, the method comprises obtaining a second reactant. In some embodiments, the second reactant comprises of the formula:

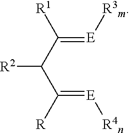

In some embodiments, each E independently comprises at least one of an oxygen, a nitrogen, or any combination thereof. In some embodiments, each of R, R¹, R², R³, and R⁴ independently comprises at least one of a hydrogen, an alkyl, a fluoroalkyl, a cycloalkyl, a fluorocycloalkyl, or any combination thereof. In some embodiments, m is 0 or 1. In some embodiments, n is 0 or 1. In some embodiments, the method comprises contacting the first reactant and the second reactant to form a reaction product. In some embodiments, the reaction product comprises a compound of the formula:

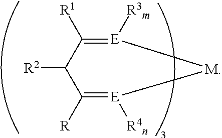

Some embodiments relate to a method. In some embodiments, the method comprises obtaining a first reactant. In some embodiments, the first reactant comprises a compound of the formula: M′ₑMX_{f}. In some embodiments, M comprises at least one of chromium, molybdenum, tungsten, or a combination thereof. In some embodiments, M′ comprises at least one of an alkali metal, an alkali earth metal, an ammonium ion, or any combination thereof. In some embodiments, e is 1 to 21. In some embodiments, X comprise a halide. In some embodiments, f is 1 to 24. In some embodiments, the method comprises obtaining a second reactant. In some embodiments, the second reactant comprises a compound of the formula:

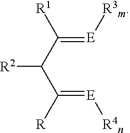

In some embodiments, each E independently comprises at least one of an oxygen, a nitrogen, or any combination thereof. In some embodiments, each of R, R¹, R², R³, and R⁴ independently comprises at least one of a hydrogen, an alkyl, a fluoroalkyl, a cycloalkyl, a fluorocycloalkyl, or any combination thereof. In some embodiments, m is 0 or 1. In some embodiments, n is 0 or 1. In some embodiments, the method comprises contacting at least the first reactant, the second reactant, and a solvent to form a solution. In some embodiments, the method comprises heating the solution to a temperature sufficient to form a reaction product. In some embodiments the reaction product comprises a compound of the formula:

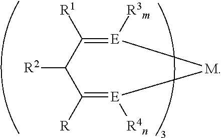

Some embodiments relate to a composition. In some embodiments, the composition comprises a precursor of the formula:

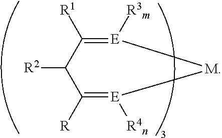

In some embodiments, M comprises at least one of a chromium, a molybdenum, a tungsten, or any combination thereof. In some embodiments, each E independently comprises at least one of an oxygen, a nitrogen, or any combination thereof. In some embodiments, each of R, R¹, R³, and R⁴ independently comprises at least one of a hydrogen, an alkyl, a fluoroalkyl, a cycloalkyl, a fluorocycloalkyl, or any combination thereof. In some embodiments, R² comprises an alkyl, a fluoroalkyl, a cycloalkyl, a fluorocycloalkyl, or any combination thereof. In some embodiments, m is 0 or 1. In some embodiments, n is 0 or 1.

Some embodiments relate to a method. In some embodiments, the method comprises obtaining a first reactant. In some embodiments, the first reactant comprises a compound of the formula:

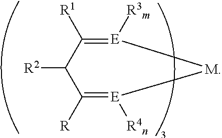

In some embodiments, M comprises at least one of a chromium, a molybdenum, a tungsten, or any combination thereof. In some embodiments, each E independently comprises at least one of an oxygen, a nitrogen, or any combination thereof. In some embodiments, each of R, R¹, R², R³, and R⁴ independently comprises at least one of a hydrogen, an alkyl, a fluoroalkyl, a cycloalkyl, a fluorocycloalkyl, or any combination thereof. In some embodiments, m is 0 or 1. In some embodiments, n is 0 or 1. In some embodiments, the method comprises obtaining a second reactant. In some embodiments, the second reactant comprises a compound of the formula:

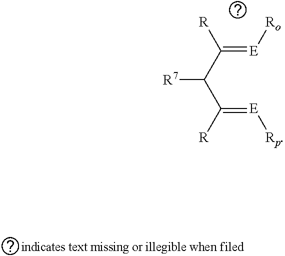

In some embodiments, each E independently comprises at least one of an oxygen, a nitrogen, or any combination thereof. In some embodiments, each of R⁵, R⁶, R⁷, R⁸, and R⁹ independently comprises at least one of a hydrogen, an alkyl, a fluoroalkyl, a cycloalkyl, a fluorocycloalkyl, or any combination thereof. In some embodiments, o is 0 or 1. In some embodiments, p is 0 or 1. In some embodiments, the method comprises contacting the first reactant and the second reactant to form a reaction product. In some embodiments, the reaction product comprises a compound of the formula:

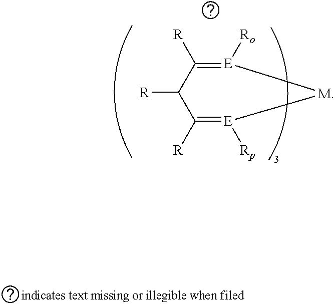

### DRAWINGS

FIG. 1 is a flowchart of a method for producing a reaction product, according to some embodiments.

FIG. 2 is a flowchart of a method for producing a reaction product, according to some embodiments.

FIG. 3 is a flowchart of a method for producing a reaction product, according to some embodiments.

FIG. 4 is a gas chromatography flame ionization detector (GC-FID) graph of the reaction product of Example 4.

FIG. 5 is a thermogravimetric analysis (TGA) graph of the reaction production of Example 4.

FIG. 6 is a graph showing the amounts of trace metals present in the reaction product of Example 4, as measured by inductively couple plasma mass spectroscopy (ICP-MS)

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

As used herein, the term “contacting” refers to bringing two or more components into immediate or close proximity, or into direct contact.

As used herein, the term “alkyl” refers to a hydrocarbyl having from 1 to 30 carbon atoms. The alkyl may be attached via a single bond. An alkyl having n carbon atoms may be designated as a “Cn alkyl.” For example, a “Cs alkyl” may include n-propyl and isopropyl. An alkyl having a range of carbon atoms, such as 1 to 30 carbon atoms, may be designated as a C₁-C₃₀ alkyl. In some embodiments, the alkyl is linear. In some embodiments, the alkyl is branched. In some embodiments, the alkyl is substituted. In some embodiments, the alkyl is substituted with at least one halide, as defined herein. An alkyl substituted with at least one halide may be designated as a “haloalkyl”. For example, a “haloalkyl” may include a fluoroalkyl. In some embodiments, the alkyl is unsubstituted. In some embodiments, the alkyl comprises or is selected from the group consisting of at least one of a C₁-C₃₀ alkyl, C₁-C₂₉ alkyl, C₁-C₂₈ alkyl, C₁-C₂₇ alkyl, C₁-C₂₇ alkyl, C₁-C₂₆ alkyl, C₁-C₂₅ alkyl, C₁-C₂₄ alkyl, C₁-C₂₃ alkyl, C₁-C₂₂ alkyl, C₁-C₂₁ alkyl, C₁-C₂₀ alkyl, C₁-C₁₉ alkyl, C₁-C₁₈ alkyl, C₁-C₁₇ alkyl, C₁-C₁₆ alkyl, C₁-C₁₅ alkyl, C₁-C₁₄ alkyl, C₁-C₁₃ alkyl, C₁-C₁₂ alkyl, C₁-C₁₁ alkyl, C₁-C₁₀ alkyl, a C₁-C₉ alkyl, a C₁-C₈ alkyl, a C₁-C₇ alkyl, a C₁-C₆ alkyl, a C₁-C₅ alkyl, a C₁-C₄ alkyl, a C₁-C₃ alkyl, a C₁-C₂ alkyl, a C₂-C₃₀ alkyl, a C₃-C₃₀ alkyl, a C₄-C₃₀ alkyl, a C₅-C₃₀ alkyl, a C₆-C₃₀ alkyl, a C₇-C₃₀ alkyl, a C₈-C₃₀ alkyl, a C₉-C₃₀ alkyl, a C₁₀-C₃₀ alkyl, a C₁₁-C₃₀ alkyl, a C₁₂-C₃₀ alkyl, a C₁₃-C₃₀ alkyl, a C₁₄-C₃₀ alkyl, a C₁₅-C₃₀ alkyl, a C₁₆-C₃₀ alkyl, a C₁₇-C₃₀ alkyl, a C₁₈-C₃₀ alkyl, a C₁₉-C₃₀ alkyl, a C₂₀-C₃₀ alkyl, a C₂₁-C₃₀ alkyl, a C₂₂-C₃₀ alkyl, a C₂₃-C₃₀ alkyl, a C₂₄-C₃₀ alkyl, a C₂₅-C₃₀ alkyl, a C₂₆-C₃₀ alkyl, a C₂₇-C₃₀ alkyl, a C₂₈-C₃₀ alkyl, a C₂₉-C₃₀ alkyl, a C₂-C₁₀ alkyl, a C₃-C₁₀ alkyl, a C₄-C₁₀ alkyl, a C₅-C₁₀ alkyl, a C₆-C₁₀ alkyl, a C₇-C₁₀ alkyl, a C₈-C₁₀ alkyl, a C₂-C₉ alkyl, a C₂-C₈ alkyl, a C₂-C₇ alkyl, a C₂-C₆ alkyl, a C₂-C₅ alkyl, a C₃-C₅ alkyl, or any combination thereof. In some embodiments, the alkyl comprises or is selected from the group consisting of at least one of methyl, ethyl, n-propyl, 1-methylethyl (iso-propyl), n-butyl, iso-butyl, sec-butyl, n-pentyl, 1,1-dimethylethyl (t-butyl), n-pentyl, iso-pentyl, n-hexyl, isohexyl, 3-methylhexyl, 2-methylhexyl, heptyl, octyl, nonyl, decyl, dodecyl, octadecyl, or any combination thereof. In some embodiments, the term “alkyl” refers generally to alkyls, alkenyls, alkynyls, and/or cycloalkyls.

As used herein, the term “alkenyl” refers to a hydrocarbyl having from 1 to 30 carbon atoms and at least one carbon-carbon double bond. An alkenyl having two carbon-carbon double bonds may be designated as a “diene”. An alkenyl having three carbon-carbon double bonds may be designated as a “triene”. An alkenyl having four carbon-carbon double bonds may be designated as a “tetraene”. An alkenyl having multiple carbon-carbon double bonds may be designated as a “polyene”. In some embodiments, the alkenyl comprises or is selected from the group consisting of at least one of a C₁-C₃₀ alkenyl, C₁-C₂₉ alkenyl, C₁-C₂₈ alkenyl, C₁-C₂₇ alkenyl, C₁-C₂₇ alkenyl, C₁-C₂₆ alkenyl, C₁-C₂₅ alkenyl, C₁-C₂₄ alkenyl, C₁-C₂₃ alkenyl, C₁-C₂₂ alkenyl, C₁-C₂₁ alkenyl, C₁-C₂₀ alkenyl, C₁-C₁₉ alkenyl, C₁-C₁₈ alkenyl, C₁-C₁₇ alkenyl, C₁-C₁₆ alkenyl, C₁-C₁₅ alkenyl, C₁-C₁₄ alkenyl, C₁-C₁₃ alkenyl, C₁-C₁₂ alkenyl, C₁-C₁₁ alkenyl, C₁-C₁₀ alkenyl, a C₁-C₉ alkenyl, a C₁-C₈ alkenyl, a C₁-C₇ alkenyl, a C₁-C₆ alkenyl, a C₁-C₅ alkenyl, a C₁-C₄ alkenyl, a C₁-C₃ alkenyl, a C₁-C₂ alkenyl, a C₂-C₃₀ alkenyl, a C₃-C₃₀ alkenyl, a C₄-C₃₀ alkenyl, a C₅-C₃₀ alkenyl, a C₆-C₃₀ alkenyl, a C₇-C₃₀ alkenyl, a C₈-C₃₀ alkenyl, a C₉-C₃₀ alkenyl, a C₁₀-C₃₀ alkenyl, a C₁₁-C₃₀ alkenyl, a C₁₂-C₃₀ alkenyl, a C₁₃-C₃₀ alkenyl, a C₁₄-C₃₀ alkenyl, a C₁₅-C₃₀ alkenyl, a C₁₆-C₃₀ alkenyl, a C₁₇-C₃₀ alkenyl, a C₁₈-C₃₀ alkenyl, a C₁₉-C₃₀ alkenyl, a C₂₀-C₃₀ alkenyl, a C₂₁-C₃₀ alkenyl, a C₂₂-C₃₀ alkenyl, a C₂₃-C₃₀ alkenyl, a C₂₄-C₃₀ alkenyl, a C₂₅-C₃₀ alkenyl, a C₂₆-C₃₀ alkenyl, a C₂₇-C₃₀ alkenyl, a C₂₈-C₃₀ alkenyl, a C₂₉-C₃₀ alkenyl, a C₂-C₁₀ alkenyl, a C₃-C₁₀ alkenyl, a C₄-C₁₀ alkenyl, a C₅-C₁₀ alkenyl, a C₆-C₁₀ alkenyl, a C₇-C₁₀ alkenyl, a C₈-C₁₀ alkenyl, a C₂-C₉ alkenyl, a C₂-C₈ alkenyl, a C₂-C₇ alkenyl, a C₂-C₆ alkenyl, a C₂-C₅ alkenyl, a C₃-C₅ alkenyl, or any combination thereof. Examples of alkenyl groups include, without limitation, at least one of vinyl, allyl, 1-methylvinyl, 1-propenyl, 1-butenyl, 2-butenyl, 3-butenyl, 1,3-butadienyl, 2-methyl-1-propenyl, 2-methyl-2-propenyl, 1-pentenyl, 2-pentenyl, 3-pentenyl, 4-pentenyl, 1,3-pentadienyl, 2,4-pentadienyl, 1,4-pentadienyl, 3-methyl-2-butenyl, 1-hexenyl, 2-hexenyl, 3-hexenyl, 1,3-hexadienyl, 1,4-hexadienyl, 2-methylpentenyl, 1-heptenyl, 3-heptenyl, 1-octenyl, 1,3-octadienyl, 1-nonenyl, 2-nonenyl, 3-nonenyl, 1-decenyl, 3-decenyl, 1-undecenyl, oleyl, linoleyl, linolenyl, or any combination thereof.

As used herein, the term “alkynyl” refers to a hydrocarbyl having from 1 to 30 carbon atoms and at least one carbon-carbon triple bond. An alkynyl having two carbon-carbon triple bonds may be designated as a “diyne”. An alkynyl having three carbon-carbon triple bonds may be designated as a “triyne”. An alkynyl having four carbon-carbon triple bonds may be designated as a “tetrayne”. An alkynyl having multiple carbon-carbon triple bonds may be designated as a “polyyne”. In some embodiments, the alkynyl comprises or is selected from the group consisting of at least one of a C₁-C₃₀ alkynyl, C₁-C₂₉ alkynyl, C₁-C₂₈ alkynyl, C₁-C₂₇ alkynyl, C₁-C₂₇ alkynyl, C₁-C₂₆ alkynyl, C₁-C₂₅ alkynyl, C₁-C₂₄ alkynyl, C₁-C₂₃ alkynyl, C₁-C₂₂ alkynyl, C₁-C₂₁ alkynyl, C₁-C₂₀ alkynyl, C₁-C₁₉ alkynyl, C₁-C₁₈ alkynyl, C₁-C₁₇ alkynyl, C₁-C₁₆ alkynyl, C₁-C₁₅ alkynyl, C₁-C₁₄ alkynyl, C₁-C₁₃ alkynyl, C₁-C₁₂ alkynyl, C₁-C₁₁ alkynyl, C₁-C₁₀ alkynyl, a C₁-C₉ alkynyl, a C₁-C₈ alkynyl, a C₁-C₇ alkynyl, a C₁-C₆ alkynyl, a C₁-C₅ alkynyl, a C₁-C₄ alkynyl, a C₁-C₃ alkynyl, a C₁-C₂ alkynyl, a C₂-C₃₀ alkynyl, a C₃-C₃₀ alkynyl, a C₄-C₃₀ alkynyl, a C₅-C₃₀ alkynyl, a C₆-C₃₀ alkynyl, a C₇-C₃₀ alkynyl, a C₈-C₃₀ alkynyl, a C₉-C₃₀ alkynyl, a C₁₀-C₃₀ alkynyl, a C₁₁-C₃₀ alkynyl, a C₁₂-C₃₀ alkynyl, a C₁₃-C₃₀ alkynyl, a C₁₄-C₃₀ alkynyl, a C₁₅-C₃₀ alkynyl, a C₁₆-C₃₀ alkynyl, a C₁₇-C₃₀ alkynyl, a C₁₈-C₃₀ alkynyl, a C₁₉-C₃₀ alkynyl, a C₂₀-C₃₀ alkynyl, a C₂₁-C₃₀ alkynyl, a C₂₂-C₃₀ alkynyl, a C₂₃-C₃₀ alkynyl, a C₂₄-C₃₀ alkynyl, a C₂₅-C₃₀ alkynyl, a C₂₆-C₃₀ alkynyl, a C₂₇-C₃₀ alkynyl, a C₂₈-C₃₀ alkynyl, a C₂₉-C₃₀ alkynyl, a C₂-C₁₀ alkynyl, a C₃-C₁₀ alkynyl, a C₄-C₁₀ alkynyl, a C₅-C₁₀ alkynyl, a C₆-C₁₀ alkynyl, a C₇-C₁₀ alkynyl, a C₈-C₁₀ alkynyl, a C₂-C₉ alkynyl, a C₂-C₈ alkynyl, a C₂-C₇ alkynyl, a C₂-C₆ alkynyl, a C₂-C₅ alkynyl, a C₃-C₅ alkynyl, or any combination thereof. Examples of alkynyl groups include, without limitation, at least one of ethynyl, propynyl, n-butynyl, n-pentynyl, 3-methyl-1-butynyl, n-hexynyl, methyl-pentynyl, or any combination thereof.

As used herein, the term “cycloalkyl” refers to a non-aromatic carbocyclic ring having from 3 to 8 carbon atoms in the ring. The term includes a monocyclic non-aromatic carbocyclic ring and a polycyclic non-aromatic carbocyclic ring. The term “monocyclic,” when used as a modifier, refers to a cycloalkyl having a single cyclic ring structure. The term “polycyclic,” when used as a modifier, refers to a cycloalkyl having more than one cyclic ring structure, which may be fused, bridged, spiro, or otherwise bonded ring structures. For example, two or more cycloalkyls may be fused, bridged, or fused and bridged to obtain the polycyclic non-aromatic carbocyclic ring. In some embodiments, the cycloalkyl is substituted. In some embodiments, the cycloalkyl is substituted with at least one halide, as defined herein. A cycloalkyl substituted with at least one halide may be designated as a “halocycloalkyl”. For example, a “halocycloalkyl” may include a fluorocycloalkyl. In some embodiments, the cycloalkyl is unsubstituted. In some embodiments, the cycloalkyl may comprise, consist of, or consist essentially of, or may be selected from the group consisting of, at least one of cyclopropyl, cyclobutyl, cyclopentyl, cyclohexyl, cycloheptyl, cyclooctyl, or any combination thereof.

As used herein, the term “cycloalkene” refers to a non-aromatic carbocyclic ring having from 3 to 8 carbon atoms with at least one double bond in the ring. The term includes a monocyclic non-aromatic carbocyclic ring and a polycyclic non-aromatic carbocyclic ring. The term “monocyclic,” when used as a modifier, refers to a cycloalkene having a single cyclic ring structure. The term “polycyclic,” when used as a modifier, refers to a cycloalkene having more than one cyclic ring structure, which may be fused, bridged, spiro, or otherwise bonded ring structures. For example, two or more cycloalkenes may be fused, bridged, or fused and bridged to obtain the polycyclic non-aromatic carbocyclic ring. In some embodiments, the cycloalkene may comprise, consist of, or consist essentially of, or may be selected from the group consisting of, at least one of cyclopropene, cyclobutene, cyclopentene, cyclohexene, cycloheptene, cyclooctene, or any combination thereof.

As used herein, the term “cycloalkyne” refers to a non-aromatic carbocyclic ring having from 3 to 12 carbon atoms with at least one triple bond in the ring. The term includes a monocyclic non-aromatic carbocyclic ring and a polycyclic non-aromatic carbocyclic ring. The term “monocyclic,” when used as a modifier, refers to a cycloalkyne having a single cyclic ring structure. The term “polycyclic,” when used as a modifier, refers to a cycloalkyne having more than one cyclic ring structure, which may be fused, bridged, spiro, or otherwise bonded ring structures. For example, two or more cycloalkynes may be fused, bridged, or fused and bridged to obtain the polycyclic non-aromatic carbocyclic ring. In some embodiments, the cycloalkyne may comprise, consist of, or consist essentially of, or may be selected from the group consisting of, at least one of cyclopropyne, cyclobutyne, cyclopentyne, cyclohexyne, cycloheptyne, cyclooctyne, cyclodecyne, cycloundecyne, or any combination thereof.

As used herein, the term “aryl” refers to a monocyclic or polycyclic aromatic hydrocarbon. The number of carbon atoms of the aryl may be in a range of 5 carbon atoms to 100 carbon atoms. In some embodiments, the aryl has 5 to 20 carbon atoms. For example, in some embodiments, the aryl has 6 to 8 carbon atoms, 6 to 10 carbon atoms, 6 to 12 carbon atoms, 6 to 15 carbon atoms, or 6 to 20 carbon atoms. The term “monocyclic,” when used as a modifier, refers to an aryl having a single aromatic ring structure. The term “polycyclic,” when used as a modifier, refers to an aryl having more than one aromatic ring structure, which may be fused, bridged, spiro, or otherwise bonded ring structures. In some embodiments, the aryl is —C₆H₅.

Non-limiting examples of aryls include, without limitation, at least one of benzene, toluene, xylene (e.g., o-xylene, m-xylene, p-xylene), t-butyltoluene (e.g., o-t-butyltoluene, m-t-butyltoluene, p-t-butyltoluene), ethylmethylbenzene (e.g., 1-ethyl-4-methylbenzene, 1-ethyl-3-methylbenzene), 1-isopropyl-4-methylbenzene, 1-t-butyl-4-methylbenzene, mesitylene, pseudocumene, durene, methylbenzene, dimethylbenzene, trimethylbenzene, ethylbenzene, diethylbenzene (e.g., 1,4-diethylbenzene), triethylbenzene, propylbenzene, butylbenzene, iso-butylbenzene, sec-butylbenzene, t-butylbenzene, hexylbenzene, styrene, naphthalene, anthracene, phenanthrene, biphenyl, terphenyl, methylnaphthalene, biphenylene, dimethylnaphthalene, methylanthracene, 4,4′-dimethylbiphenyl, bibenzyl, diphenylmethane, cyclopentadienyl, any isomer thereof, or any combination thereof, and the like.

As used herein, the term “amino” and/or “amine” refers to a functional group of formula —N(R^{a}R^{b}), wherein R^{a} and R^{b} are independently a hydrogen, an alkyl (as defined herein), an aminoalkyl (as defined herein), a silyl (as defined herein), a cycloalkyl, an aryl, or a heterocyclic. In some embodiments, the amino may comprise an alkylamino or a dialkylamino. In some embodiments, the amino may comprise at least one of methylamino, dimethylamino, ethylamino, diethylamino, isopropylamino, di-isopropylamino, butylamino, sec-butylamino, tert-butylamino, di-sec-butylamino, isobutylamino, di-isobutylamino, di-tert-pentylamino, ethylmethylamino, isopropyl-n-propylamino, or any combination thereof. Examples of the alkylamines may include, without limitation, one or more of the following: primary alkylamines, such as, for example and without limitation, methylamine, ethylamine, n-propylamine, isopropylamine, n-butylamine, sec-butylamine, isobutylamine, t-butylamine, pentylamine, 2-aminopentane, 3-aminopentane, 1-amino-2-methylbutane, 2-amino-2-methylbutane, 3-amino-2-methylbutane, 4-amino-2-methylbutane, hexylamine, 5-amino-2-methylpentane, heptylamine, octylamine, nonylamine, decylamine, undecylamine, dodecylamine, tridecylamine, tetradecylamine, pentadecylamine, hexadecylamine, heptadecylamine, and octadecylamine; secondary alkylamines, such as, for example and without limitation, dimethylamine, diethylamine, dipropylamine, diisopropylamine, dibutylamine, diisobutylamine, di-sec-butylamine, di-t-butylamine, dipentylamine, dihexylamine, diheptylamine, dioctylamine, dinonylamine, didecylamine, methylethylamine, methylpropylamine, methylisopropylamine, methylbutylamine, methylisobutylamine, methyl-sec-butylamine, methyl-t-butylamine, methylamylamine, methylisoamylamine, ethylpropylamine, ethylisopropylamine, ethylbutylamine, ethylisobutylamine, ethyl-sec-butylamine, ethylamine, ethylisoamylamine, propylbutylamine, and propylisobutylamine; and tertiary alkylamines, such as, for example and without limitation, trimethylamine, triethylamine, tripropylamine, tributylamine, tripentylamine, dimethylethylamine, methyldiethylamine, and methyldipropylamine. Examples of polyamines may include, without limitation, one or more of the following: ethylenediamine, propylenediamine, trimethylenediamine, tetramethylenediamine, 1,3-diaminobutane, 2,3-diaminobutane, pentamethylenediamine, 2,4-diaminopentane, hexamethylenediamine, heptamethylenediamine, octamethylenediamine, nonamethylenediamine, N-methylethylenediamine, N,N-dimethylethylenediamine, trimethylethylenediamine, N-ethylethylenediamine, N,N-diethylethylenediamine, triethylethylenediamine, 1,2,3-triaminopropane, hydrazine, tris(2-aminoethyl)amine, tetra(aminomethyl)methane, diethylenetriamine, triethylenetetramine, tetraethylpentamine, heptaethyleneoctamine, nonaethylenedecamine, and diazabicyloundecene. Unless otherwise provided herein, the terms “amine” and “amino” may be used interchangeably throughout this disclosure.

As used herein, the term “hydroxyl” refers to a functional group of the formula —OH.

As used herein, the term “alkoxy” or “alkoxide” refers to a functional group of formula —OR^{c}, wherein R^{c} is an alkyl (as defined herein), a silylalkyl, a cycloalkyl, or an aryl. In some embodiments, the alkoxy may comprise, consist of, or consist essentially of, or may selected from the group consisting of, at least one of methoxy, ethoxy, methoxy, ethoxy, n-propoxy, 1-methylethoxy (isopropoxy), n-butoxy, iso-butoxy, sec-butoxy, tert-butoxy, or any combination thereof.

As defined herein, the term “polyol” refers to a functional group with multiple hydroxyls (as defined herein). A polyol with two hydroxyls may be designated as a “diol”. A polyol with three hydroxyls may be designated as a “triol”. A polyol with four hydroxyls may be designated as a “tetrol”.

As used herein, the term “silyl” refers to a functional group of formula —Si(R^{e}R^{f}R^{g}), where each of R^{e}, R^{f}, and R^{g} is independently a hydrogen or an alkyl, as defined herein. In some embodiments, the silyl is a functional group of formula —SiH₃. In some embodiments, the silyl is a functional group of formula —SiR^{e}H₂, where R^{e} is not hydrogen. In some embodiments, the silyl is a functional group of formula —SiR^{e}R^{f}H, where R^{e} and R^{f} are not hydrogen. In some embodiments, the silyl is a functional group of the formula —Si(R^{e}R^{f}R^{g}), where R^{e}, R^{f}, and R^{g} are not hydrogen. In some embodiments, the silyl is a functional group of formula —Si(CH₃)₃.

As used herein, the term “alkoxyalkyl” refers to an alkyl as defined herein, wherein at least one of the hydrogen atoms of the alkyl is replaced with an alkoxy as defined herein. In some embodiments, the term “alkoxyalkyl” refers to a functional group of formula —(alkyl)OR^{a}, wherein the alkyl is defined above and wherein the R^{a} is defined above. In some embodiments, the alkoxyalkyl is a functional group of formula —(CH₂)ₙOR^{a}, where n is 1 to 10 and R^{a} is defined above. In some embodiments, the alkoxyalkyl is a functional group of the formula —CH₂CH₂OCH₃.

As used herein, the term “aralkyl” refers to an alkyl as defined herein, wherein at least one of the hydrogen atoms of the alkyl is replaced with an aryl as defined herein. In some embodiments, the term “aralkyl” refers to a functional group of formula -(alkyl)(aryl), wherein the alkyl is defined herein and the aryl is defined herein. In some embodiments, the aralkyl is —CH₂(C₆H₅).

As used herein, the term “aminoalkyl” refers to an alkyl as defined herein, wherein at least one of the hydrogen atoms of the alkyl is replaced with an amino as defined herein. In some embodiments, the term “aminoalkyl” refers to a functional group of formula —(alkyl)N(R^{b}R^{c}R^{d}), wherein the alkyl is defined above and wherein R^{b}, R^{c}, and R^{d} are defined above. In some embodiments, the aminoalkyl is —CH₂N(CH₃)₂. In some embodiments, the aminoalkyl is —(CH₂)₃N(CH₃)₂. In some embodiments, the aminoalkyl is aminomethyl (—CH₂NH₂). In some embodiments, the aminoalkyl is N,N-dimethylaminoethyl (—CH₂CH₂N(CH₃)₂). In some embodiments, the aminoalkyl is 3-(N-cyclopropylamino)propyl (—CH₂CH₂CH₂NH—Pr).

As used herein, the term “silylalkyl” refers to an alkyl as defined herein, wherein at least one of the hydrogen atoms of the alkyl is replaced with a silyl as defined herein. In some embodiments, the term “silylalkyl” refers to a functional group of formula -(alkyl)Si(R^{e}R^{f}R^{g}), wherein the alkyl is defined above and wherein R^{e}, R^{f}, and R^{g} are defined above. In some embodiments, the silylalky is a functional group of formula —(CH₂)ₘSi(R^{e}R^{f}R^{g}), where m is 1 to 10 and where R^{e}, R^{f}, and R^{g} are defined above. In some embodiments, the silylalkyl is a functional group of formula —CH₂Si(CH₃)₃.

As used herein, the term “carbonyl” refers to a functional group of the formula C═O, consisting of a carbon atom double-bonded to an oxygen atom.

As used herein, the term “nitrile” refers to a functional group of the formula —C≡N.

As used herein, the term “isonitrile” refers to a functional group of the formula —N═C.

As used herein, the term “thioalkyl” refers to a functional group of the formula —SR, wherein Ris an alkyl, as defined herein.

As used herein, the term “phosphino” and/or “phosphido” refers to a functional group of the formula —PR^{a}R^{b}, wherein R^{a} and R^{b} are each independently a hydrogen, an alkyl (as defined herein), or an aryl (as defined herein).

As used herein, the term “heterocyclic” refers to an aromatic or non-aromatic ring having 3 to 8 atoms and at least two different elements as members of the ring. The at least two different elements are carbon, oxygen, nitrogen, sulfur, and phosphorous. In some embodiments, the heterocyclic may comprise, consist of, or consist essentially of, or may be selected from the group consisting of, at least one of an aromatic nitrogen-containing ring, a non-aromatic nitrogen-containing ring, an aromatic oxygen-containing ring, a non-aromatic oxygen-containing ring, an aromatic sulfur-containing ring, a non-aromatic sulfur-containing ring, an aromatic phosphorous-containing ring, a non-aromatic phosphorous-containing ring, or any combination thereof. Examples of heterocyclics may include, without limitation, one or more of the following: pyridine, pyrrole, furan, thiophene, imidazolidine, imidazole, quinoline, indole, pyrazole, triazole, tetrazole, pyrimidine, quinoxaline, isoquinoline, benzimidazole, carbazole, pyran, dioxane, coumarin, phosphirane, phosphole, phosphorinane, phosphorin, phospholane, thiophene, thiazole, benzothiophene, thiazine, thiazolidine, dithiane, or any combination thereof.

As used herein, the term “amidino” and/or “amidinato” refers to a functional group of the formula —C(═NR^{a})N(R^{b}R^{c}), wherein R^{a}, R^{b}, and R^{c} are each independently a hydrogen or an alkyl, as defined here. In some embodiments, the term “amidino” refers to a functional group of formula —C(═NH)N(R^{b}R^{c}), where R^{b} and R^{e} are not hydrogen. In some embodiments, the term “amidino” refers to a functional group of formula —C(═NR^{a})N(HR^{c}), where R^{a} and R^{c} are not hydrogen. In some embodiments, the term “amidino” refers to a functional group of formula —C(═NH)N(HR^{c}), where R^{c} is not hydrogen. In some embodiments, the term “amidino” refers to a functional group of formula —C(═NR^{a})N(R^{b}R^{c}), wherein R^{a}, R^{b}, and R^{c} are not hydrogen.

As used herein, the term “guanidino” refers to a functional group of the formula —C(═NR^{a})N(R^{b}R^{c})N(R^{d}R^{e}), wherein R^{a}, R^{b}, R^{c}, R^{d}, and R^{e} are each independently a hydrogen or an alkyl, as defined here. In some embodiments, the term “guanidino” refers to a functional group of formula —C(═NH)N(R^{b}R^{c})N(R^{d}R^{e}), wherein R^{b}, R^{c}, R^{d}, and R^{e} are not hydrogen. In some embodiments, the term “guanidino” refers to a functional group of formula —C(═NR^{a})N(HR^{c})N(R^{d}R^{e}), wherein R^{a}, R^{c}, R^{d}, and R^{e} are not hydrogen. In some embodiments, the term “guanidino” refers to a functional group of formula —C(═NRª)N(H₂)N(R^{d}R^{e}), wherein R^{a}, R^{d}, and R^{e} are not hydrogen. In some embodiments, the term “guanidino” refers to a functional group of formula —C(═NH)N(HR^{c})N(R^{d}R^{e}), wherein R^{c}, R^{d}, and R^{e} are not hydrogen. In some embodiments, the term “guanidino” refers to a functional group of formula —C(═NR^{a})N(H₂)N(HR^{e}), wherein R^{a} and R^{e} are not hydrogen. In some embodiments, the term “guanidino” refers to a functional group of formula —C(═NH)N(H²)N(HR^{e}), wherein R^{e} is not hydrogen.

As used herein, the term “sulfoxide” refers to a functional group of the formula —S(═O)R, wherein R is an alkyl (as defined herein) or an aryl (as defined herein).

As used herein, the term “ester” refers to a functional group of the formula —C(═O)OR, wherein R is an alkyl (as defined herein) or an aryl (as defined herein).

As used herein, the term “anhydride” refers to a functional group of the formula —C(═O)OC(═O)R, wherein the R is an alkyl (as defined herein) or an aryl (as defined herein.

As used herein, the term “halide” refers to a —Cl, —Br, —I, or —F.

As used herein, the term “aquo” refers to a complex in which water molecules are directed bonded to a central metal ion. For example, “hexaaquochromium(III)” refers to a chromium complex where six water molecules are directly bonded to a chromium with an oxidation state of three.

As used herein, the term “sulfonyl” refers to a functional group of the formula —S(═O)₂R, wherein R is a hydrogen, an alkyl (as defined herein), an aryl (as defined herein), or an amine (as defined herein).

As used herein, the term “hydrazino” refers to a functional group of the formula —NHNH₂.

As used herein, the term “hydrazido” refers to a functional group of the formula ═N—NH₂.

As used herein, the term “hydrazonato” refers to a functional group of the formula (R^{a})₂C═NN(R^{b})₂, wherein each R^{a} and R^{b} are independently a hydrogen, an alkyl (as described herein), or an aryl (as described herein).

As used herein, the term “imido” refers to a functional group of the formula ═NR, wherein R is a hydrogen, an alkyl (as described herein), or an aryl (as described herein).

As used herein, the term “triflate” refers to a functional group of the formula —O—S(═O)₂—CF₃.

As used herein, the term “tosylate” refers to a functional group of the formula —O—S(═O)₂—C₆H₄—CH₃, where C₆H₄ is a toluene.

As used herein, the term “mesylate” refers to a functional group of the formula —O—S(═O)₂—CH₃.

As used herein, the term “amido” refers to a functional group of the formula —R^{a}—C(═O)NR^{b}R^{c}, wherein R^{a} is an alkyl (as described herein) or an aryl (as described herein) and each of R^{b} and R^{e} are independently a hydrogen, an alkyl (as described herein), or an aryl (as described herein).

As used herein, the term “iminato” refers to a functional group of the formula —(R^{a})N═CR^{b}R^{c}, wherein each of R^{a}, R^{b}, and R^{c} are independently a hydrogen, an alkyl (as described herein), or an aryl (as described herein).

As used herein, the term “β-diketiminato” refers to a functional group of the formula (R^{a})₂═N—C(R^{b})—N═₂C(R^{c})₂, wherein each of R^{a}, R^{b}, and R^{c} are independently a hydrogen, an alkyl (as described herein), or an aryl (as described herein).

As used here, the term “β-diketonato” refers to a functional group of the formula R^{a}—C(═O)—CH₂—C(═O)—R^{b}, wherein each of R^{a} and R^{b} are independently a hydrogen, an alkyl (as described herein), or an aryl (as described herein).

As used herein, the term “propiolamidinato” refers to a functional group of the formula R^{a}—C═C—C(═NR^{b})—N(R^{c})₂, wherein each of R^{a}, R^{b}, and R^{c} are independently a hydrogen, an alkyl (as described herein), or an aryl (as described herein).

As used herein, the term “amidoximato” refers to a functional group of the formula R^{a}—C(═NOH)—N(R^{b})₂, wherein R^{a} is an alkyl (as described herein) or an aryl (as described herein) and each Rb is independently a hydrogen, an alkyl (as described herein), or an aryl (as described herein).

Some embodiments relate to precursors and related methods. At least some of these embodiments relate to precursors useful in the fabrication of microelectronic devices, including semiconductor devices, and the like. For example, the precursors can be used to form silicon-containing films by one or more deposition processes. Examples of deposition processes include, without limitation, at least one of a chemical vapor deposition (CVD) process, a digital or pulsed chemical vapor deposition process, a plasma-enhanced cyclical chemical vapor deposition process (PECCVD), a flowable chemical vapor deposition process (FCVD), an atomic layer deposition (ALD) process, a thermal atomic layer deposition, a plasma-enhanced atomic layer deposition (PEALD) process, a metal organic chemical vapor deposition (MOCVD) process, a plasma-enhanced chemical vapor deposition (PECVD) process, or any combination thereof.

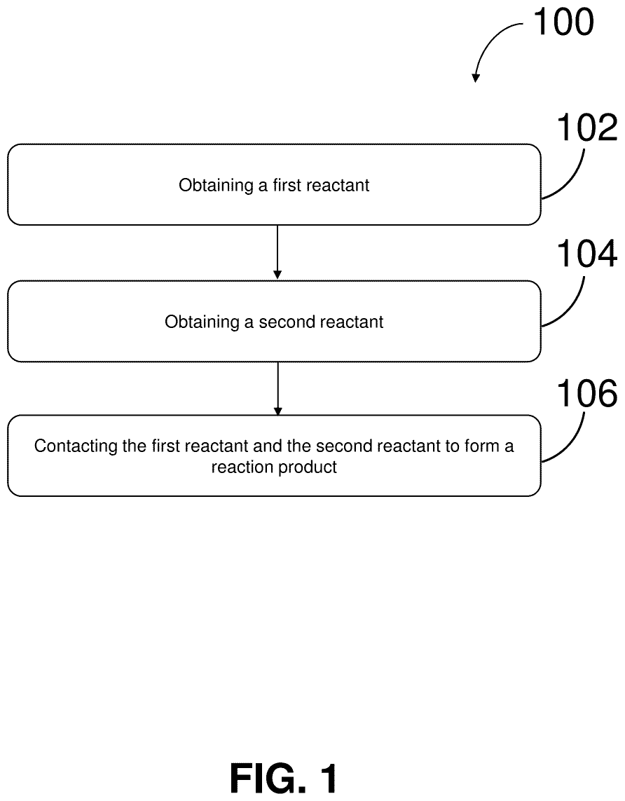

FIG. 1 is a flowchart of a method for forming a reaction product 100, according to some embodiments. As shown in FIG. 1, the method for forming a reaction product 100 may comprise one or more of the following steps: obtaining 102 a first reactant, obtaining 104 a second reactant, and contacting 106 the first reactant and the second reactant to form a reaction product.

At step 102, in some embodiments, the method comprises obtaining a first reactant. In some embodiments, the first reactant comprises the formula:

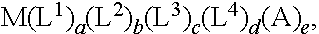

where:
M comprises at least one of a chromium, a molybdenum, a tungsten, or any combination thereof;
each of L¹, L², L³, and L⁴ independently comprises at least one of an amine, a carbon monoxide, a carbonyl, a nitrile, an isonitrile, a thioalkyl, a sulfoxide, an ester, an alkoxy, a polyol, an anhydride, a heterocyclic, a phosphine, a guanidino, an amidino, an alkenyl, a cycloalkenyl, an alkynyl, a cycloalkynyl, an aryl, a dinitrogen, an aquo, a nitric oxide, a sulfonyl, or any combination thereof;
a is 0 to 6;
b is 0 to 6;
c is 0 to 6;
d is 0 to 6;
A comprises an anionic type ligand comprising at least one of an alkyl, an allyl, an alkenyl, an alkynyl, a cycloalkyl, a cycloalkenyl, a cycloalkynyl, a haloalkyl, a halocycloalkyl, a hydride, an aryl, a hydrazino, a hydrazido, an imido, a halide, a triflate, a tosylate, a mesylate, an amido, an iminato, an amidinato, a β-diketiminato, β-diketonato, propiolamidinato, amidoximato, hydrazonato, a phosphide, or any combination thereof;
wherein e is 0 to 6; and
a+b+c+d+e is 1 to 8.

In some embodiments, M comprises at least one of chromium, molybdenum, tungsten, or any combination thereof. In some embodiments, M comprises a chromium. In some embodiments, M comprises a molybdenum. In some embodiments, M comprises a tungsten.

In some embodiments, each of L¹, L², L³, and L⁴ independently comprises at least one of an amine, a carbon monoxide, a carbonyl, a nitrile, an isonitrile, a thioalkyl, a sulfoxide, an ester, an alkoxy, a polyol, an anhydride, a heterocyclic, a phosphine, a guanidino, an amidino, an alkenyl, a cycloalkenyl, an alkynyl, a cycloalkynyl, an aryl, a dinitrogen, an aquo, a nitric oxide, a sulfonyl, or any combination thereof. In some embodiments, each L is the same. In some embodiments, each L is different. In some embodiments, at least two of L¹, L², L³, and L⁴ are the same. In some embodiments, at least two of L¹, L², L³, and L⁴ are different. In some embodiments, at least three of L¹, L², L³, and L⁴ are the same. In some embodiments, at least three of L¹, L², L³, and L⁴ are different. In some embodiments, at least one of L¹, L², L³, and L⁴ comprises an amine. In some embodiments, at least one of L¹, L², L³, and L⁴ comprises a carbon monoxide. In some embodiments, at least one of L¹, L², L³, and L⁴ comprises a carbonyl. In some embodiments, at least one of L¹, L², L³, and L⁴ comprises a nitrile. In some embodiments, at least one of L¹, L², L³, and L⁴ comprises an isonitrile. In some embodiments, at least one of L¹, L², L³, and L⁴ comprises a thioalkyl. In some embodiments, at least one of L¹, L², L³, and L⁴ comprises a sulfoxide. In some embodiments, at least one of L¹, L², L³, and L⁴ comprises an ester. In some embodiments, at least one of L¹, L², L³, and L⁴ comprises an alkoxy. In some embodiments, at least one of L¹, L², L³, and L⁴ comprises a polyol. In some embodiments, at least one of L¹, L², L³, and L⁴ comprises an anhydride. In some embodiments, at least one of L¹, L², L³, and L⁴ comprises a heterocyclic. In some embodiments, at least one of L¹, L², L³, and L⁴ comprises a phosphine. In some embodiments, at least one of L¹, L², L³, and L⁴ comprises a guanidino. In some embodiments, at least one of L¹, L², L³, and L⁴ comprises an amidino. In some embodiments, at least one of L¹, L², L³, and L⁴ comprises an alkenyl. In some embodiments, at least one of L¹, L², L³, and L⁴ comprises a cycloalkenyl. In some embodiments, at least one of L¹, L², L³, and L⁴ comprises an alkynyl. In some embodiments, at least one of L¹, L², L³, and L⁴ comprises a cycloalkynyl. In some embodiments, at least one of L¹, L², L³, and L⁴ comprises an aryl. In some embodiments, at least one of L¹, L², L³, and L⁴ comprises a dinitrogen. In some embodiments, at least one of L¹, L², L³, and L⁴ comprises an aquo. In some embodiments, at least one of L¹, L², L³, and L⁴ comprises a nitric oxide. In some embodiments, at least one of L¹, L², L³, and L⁴ comprises a sulfonyl.

In some embodiments, a is 0 to 6, or any range or subrange between 0 to 6. In some embodiments, a is 1 to 6, 2 to 6, 3 to 6, 4 to 6, 5 to 6, 0 to 5, 0 to 4, 0 to 3, 0 to 2, or 0 to 1. In some embodiments, a is 0. In some embodiments, a is 1. In some embodiments, a is 2. In some embodiments, a is 3. In some embodiments, a is 4. In some embodiments, a is 5. In some embodiments, a is 6.

In some embodiments, b is 0 to 6, or any range or subrange between 0 to 6. In some embodiments, b is 1 to 6, 2 to 6, 3 to 6, 4 to 6, 5 to 6, 0 to 5, 0 to 4, 0 to 3, 0 to 2, or 0 to 1. In some embodiments, b is 0. In some embodiments, b is 1. In some embodiments, b is 2. In some embodiments, b is 3. In some embodiments, b is 4. In some embodiments, b is 5. In some embodiments, b is 6.

In some embodiments, c is 0 to 6, or any range or subrange between 0 to 6. In some embodiments, c is 1 to 6, 2 to 6, 3 to 6, 4 to 6, 5 to 6, 0 to 5, 0 to 4, 0 to 3, 0 to 2, or 0 to 1. In some embodiments, c is 0. In some embodiments, c is 1. In some embodiments, c is 2. In some embodiments, c is 3. In some embodiments, c is 4. In some embodiments, c is 5. In some embodiments, c is 6.

In some embodiments, d is 0 to 6, or any range or subrange between 0 to 6. In some embodiments, d is 1 to 6, 2 to 6, 3 to 6, 4 to 6, 5 to 6, 0 to 5, 0 to 4, 0 to 3, 0 to 2, or 0 to 1. In some embodiments, d is 0. In some embodiments, d is 1. In some embodiments, d is 2. In some embodiments, d is 3. In some embodiments, d is 4. In some embodiments, d is 5. In some embodiments, d is 6.

In some embodiments, A comprises an anionic type ligand. In some embodiments, A comprises at least one of an alkyl, an allyl, an alkenyl, an alkynyl, a cycloalkyl, a cycloalkenyl, a cycloalkynyl, a haloalkyl, a halocycloalkyl, a hydride, an aryl, a hydrazino, a hydrazido, an imido, a halide, a triflate, a tosylate, a mesylate, an amido, an iminato, an amidinato, a β-diketiminato, β-diketonato, propiolamidinato, amidoximato, hydrazonato, a phosphide, or any combination thereof. In some embodiments, A comprises an alkyl. In some embodiments, A comprises an allyl. In some embodiments, A comprises an alkenyl. In some embodiments, A comprises an alkynyl. In some embodiments, A comprises a cycloalkyl. In some embodiments, A comprises a cycloalkenyl. In some embodiments, A comprises a cycloalkynyl. In some embodiments, A comprises a haloalkyl. In some embodiments, A comprises a halocycloalkyl. In some embodiments, A comprises a hydride. In some embodiments, A comprises an aryl. In some embodiments, A comprises a hydrazine. In some embodiments, A comprises a hydrazido. In some embodiments, A comprises an imido. In some embodiments, A comprises a halide. In some embodiments, A comprises a triflate. In some embodiments, A comprises a tosylate. In some embodiments, A comprises a mesylate. In some embodiments, A comprises an amido. In some embodiments, A comprises an iminato. In some embodiments, A comprises an amidinato. In some embodiments, A comprises a β-diketiminato. In some embodiments, A comprises a β-diketonato. In some embodiments, A comprises a propiolamidinato. In some embodiments, A comprises an amidoximato. In some embodiments, A comprises a hydrazonato. In some embodiments, A comprises a phosphide.

In some embodiments, e is 0 to 6, or any range or subrange between 0 to 6. In some embodiments, e is 1 to 6, 2 to 6, 3 to 6, 4 to 6, 5 to 6, 0 to 5, 0 to 4, 0 to 3, 0 to 2, or 0 to 1. In some embodiments, e is 0. In some embodiments, e is 1. In some embodiments, e is 2. In some embodiments, e is 3. In some embodiments, e is 4. In some embodiments, e is 5. In some embodiments, e is 6.

In some embodiments, a+b+c+d+e is 1 to 8, or any range or subrange between 1 to 8. In some embodiments, a+b+c+d+e is 1 to 7, 1 to 6, 1 to 5, 1 to 4, 1 to 3, 1 to 2, 2 to 8, 3 to 8, 4 to 8, 5 to 8, 6 to 8, or 7 to 8. In some embodiments, a+b+c+d+e is 1. In some embodiments, a+b+c+d+e is 2. In some embodiments, a+b+c+d+e is 3. In some embodiments, a+b+c+d+e is 4. In some embodiments, a+b+c+d+e is 5. In some embodiments, a+b+c+d+e is 6. In some embodiments, a+b+c+d+e is 7. In some embodiments, a+b+c+d+e is 8.

In some embodiments, at least one of L¹, L², L³, L⁴, A, or any combination thereof is a ligand bridging two or more metal centers, M. In some embodiments, at least one of L¹, L², L³, L⁴, A, or any combination thereof is a ligand bridging two to six metal centers, M. In some embodiments, at least one of L¹, L², L³, L⁴, A, or any combination thereof is a ligand bridging three or more metal centers, M. In some embodiments, at least one of L¹, L², L³, L⁴, A, or any combination thereof is a ligand bridging four or more metal centers, M. In some embodiments, at least one of L¹, L², L³, L⁴, A, or any combination thereof is a ligand bridging five or more metal centers, M. In some embodiments, at least one of L¹, L², L³, L⁴, A, or any combination thereof is a ligand bridging six metal centers, M.

In some embodiments, at least two of L¹, L², L³, L⁴, A, or any combination thereof are ligands bridging two or more metal centers, M. In some embodiments, at least two of L¹, L², L³, L⁴, A, or any combination thereof is a ligand bridging two to six metal centers, M. In some embodiments, at least two of L¹, L², L³, L⁴, A, or any combination thereof is a ligand bridging three or more metal centers, M. In some embodiments, at least two of L¹, L², L³, L⁴, A, or any combination thereof is a ligand bridging four or more metal centers, M. In some embodiments, at least two of L¹, L², L³, L⁴, A, or any combination thereof is a ligand bridging five or more metal centers, M. In some embodiments, at least two of L¹, L², L³, L⁴, A, or any combination thereof is a ligand bridging six metal centers, M.

In some embodiments, at least three of L¹, L², L³, L⁴, A, or any combination thereof are ligands bridging two or more metal centers, M. In some embodiments, at least three of L¹, L², L³, L⁴, A, or any combination thereof is a ligand bridging two to six metal centers, M. In some embodiments, at least three of L¹, L², L³, L⁴, A, or any combination thereof is a ligand bridging three or more metal centers, M. In some embodiments, at least three of L¹, L², L³, L⁴, A, or any combination thereof is a ligand bridging four or more metal centers, M. In some embodiments, at least three of L¹, L², L³, L⁴, A, or any combination thereof is a ligand bridging five or more metal centers, M. In some embodiments, at least three of L¹, L², L³, L⁴, A, or any combination thereof is a ligand bridging six metal centers, M.

In some embodiments, at least four of L¹, 1, L², L³, L⁴, A, or any combination thereof are ligands bridging two or more metal centers, M. In some embodiments, at least four of L¹, L², L³, L⁴, A, or any combination thereof is a ligand bridging two to six metal centers, M. In some embodiments, at least four of L¹, L², L³, L⁴, A, or any combination thereof is a ligand bridging three or more metal centers, M. In some embodiments, at least four of L¹, L², L³, L⁴, A, or any combination thereof is a ligand bridging four or more metal centers, M. In some embodiments, at least four of L¹, L², L³, L⁴, A, or any combination thereof is a ligand bridging five or more metal centers, M. In some embodiments, at least four of L¹, L², L³, L⁴, A, or any combination thereof is a ligand bridging six metal centers, M.

In some embodiments, each of L¹, L², L³, L⁴, A, or any combination thereof are ligands bridging two or more metal centers, M. In some embodiments, each of L¹, L², L³, L⁴, A, or any combination thereof is a ligand bridging two to six metal centers, M. In some embodiments, each of L¹, L², L³, L⁴, A, or any combination thereof is a ligand bridging three or more metal centers, M. In some embodiments, each of L¹, L², L³, L⁴, A, or any combination thereof is a ligand bridging four or more metal centers, M. In some embodiments, each of L¹, L², L³, L⁴, A, or any combination thereof is a ligand bridging five or more metal centers, M. In some embodiments, each of L¹, L², L³, L⁴, A, or any combination thereof is a ligand bridging six metal centers, M.

In some embodiments, the first reactant comprises the formula: Mo(CO)₆.

In some embodiments, the obtaining may comprise obtaining a container or other vessel comprising the first reactant.

At step 104, in some embodiments, the method comprises obtaining a second reactant. In some embodiments, the second reactant comprises of the formula:

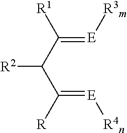

where:
each E independently comprises at least one of an oxygen, a nitrogen, or any combination thereof;
each of R, R¹, R², R³, and R⁴ independently comprises at least one of a hydrogen, an alkyl, a fluoroalkyl, a cycloalkyl, a fluorocycloalkyl, or any combination thereof;
m is 0 or 1; and
n is 0 or 1.

In some embodiments, each E independently comprises at least one of an oxygen, a nitrogen, or any combination thereof. In some embodiments, each E is different. In some embodiments, each E is the same. In some embodiments, each E is oxygen. In some embodiments, each E is nitrogen. In some embodiments, one E is oxygen and the other E is nitrogen.

In some embodiments, each of R, R¹, R², R³, and R⁴ independently comprises at least one of a hydrogen, an alkyl, a fluoroalkyl, a cycloalkyl, a fluorocycloalkyl, or any combination thereof. In some embodiments, each of R, R¹, R², R³, and R⁴ are different. In some embodiments, each of R, R¹, R², R³, and R⁴ are the same. In some embodiments, at least two of R, R¹, R², R³, and R⁴ are the same. In some embodiments, at least two of R, R¹, R², R³, and R⁴ are different. In some embodiments, at least three of R, R¹, R², R³, and R⁴ are the same. In some embodiments, at least three of R, R¹, R², R³, and R⁴ are different. In some embodiments, at least four of R, R¹, R², R³, and R⁴ are the same. In some embodiments, at least four of R, R¹, R², R³, and R⁴ are different.

In some embodiments, m is 0 or 1. In some embodiments, m is 0. In some embodiments, m is 1.

In some embodiments, n is 0 or 1. In some embodiments, n is 0. In some embodiments, n is 1.

In some embodiments, m and n are the same. In some embodiments, m and n are different.

In some embodiments, the second reactant comprises a compound of the formula:

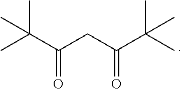

In some embodiments, the second reactant comprises a compound of the formula:

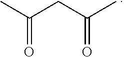

In some embodiments, the obtaining may comprise obtaining a container or other vessel comprising the second reactant.

At step 106, in some embodiments, the method comprises contacting the first reactant and the second reactant to form a reaction product. In some embodiments, the second reactant is provided in excess of the first reactant. In some embodiments, the second reactant is provided in an amount sufficient to fully convert the first reactant to the reaction product. In some embodiments, the second reactant is provided in equal amounts to the first reactant. In some embodiments, the method does comprise the use of a solvent. In some embodiments, the contacting comprises mixing the first reactant and the second reactant. In some embodiments, the contacting comprises stirring the first reactant and second reactant together.

In some embodiments, the contacting comprises heating the first reactant and second reactant to form the reaction product. In some embodiments, the heating comprises heating to a temperature of 50° C. to 250° C., or any range or subrange between 50° C. to 250° C. In some embodiments, the heating comprises heating to a temperature of 50° C. to 240° C., 50° C. to 230° C., 50° C. to 220° C., 50° C. to 210° C., 50° C. to 200° C., 50° C. to 190° C., 50° C. to 180° C., 50° C. to 170° C., 50° C. to 160° C., 50° C. to 150° C., 50° C. to 140° C., 50° C. to 130° C., 50° C. to 120° C., 50° C. to 110° C., 50° C. to 100° C., 50° C. to 90° C., 50° C. to 80° C., 50° C. to 70° C., 50° C. to 60° C., 60° C. to 250° C., 70° C. to 250° C., 80° C. to 250° C., 90° C. to 250° C., 100° C. to 250° C., 110° C. to 250° C., 120° C. to 250° C., 130° C. to 250° C., 140° C. to 250° C., 150° C. to 250° C., 160° C. to 250° C., 170° C. to 250° C., 180° C. to 250° C., 190° C. to 250° C., 200° C. to 250° C., 210° C. to 250° C., 220° C. to 250° C., 230° C. to 250° C., or 240° C. to 250° C.

In some embodiments, the contact comprises contacting the first reactant and the second reactant for a time period of 30 minutes to 48 hours, or any range or subrange between 30 minutes to 48 hours. In some embodiments, the contacting comprises contacting the first reactant and the second reactant for a time period of 30 minutes to 46 hours, 30 minutes to 44 hours, 30 minutes to 42 hours, 30 minutes to 40 hours, 30 minutes to 38 hours, 30 minutes to 36 hours, 30 minutes to 34 hours, 30 minutes to 32 hours, 30 minutes to 30 hours, 30 minutes to 28 hours, 30 minutes to 26 hours, 30 minutes to 24 hours, 30 minutes to 22 hours, 30 minutes to 20 hours, 30 minutes to 18 hours, 30 minutes to 16 hours, 30 minutes to 14 hours, 30 minutes to 12 hours, 30 minutes to 10 hours, 30 minutes to 8 hours, 30 minutes to 6 hours, 30 minutes to 4 hours, 30 minutes to 2 hours, 30 minutes to 1 hour, 1 hour to 48 hours, 2 hours to 48 hours, 4 hours to 48 hours, 6 hours to 48 hours, 8 hours to 48 hours, 10 hours to 48 hours, 12 hours to 48 hours, 14 hours to 48 hours, 16 hours to 48 hours, 18 hours to 48 hours, 20 hours to 48 hours, 22 hours to 48 hours, 24 hours to 48 hours, 26 hours to 48 hours, 28 hours to 48 hours, 30 hours to 48 hours, 32 hours to 48 hours, 34 hours to 48 hours, 36 hours to 48 hours, 38 hours to 48 hours, 40 hours to 48 hours, 42 hours to 48 hours, 44 hours to 48 hours, or 46 hours to 48 hours.

In some embodiments, the reaction product comprises a compound of the formula:

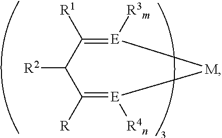

where M, E, R, R¹, R², R³, R⁴, m, and n are as defined above.

In some embodiments, the reaction product has a purity of 90% or greater as measured by gas chromatography-mass spectrometry (GC-MS). In some embodiments, the reaction product has a purity of 91% or greater, 92% or greater, 93% or greater, 94% or greater, 95% or greater, 96% or greater, 97% or greater, 98% or greater, 99% or greater, 99.9% or greater, or 99.99% or greater, as measured by GC-MS. In some embodiments, the reaction product has a purity of 90% to 99.999%, or any range or subrange between 90% to 99.999%, as measured by GC-MS. In some embodiments, the reaction product has a purity of 90% to 99.995%, 90% to 99.99%, 90% to 99.95%, 90% to 99.9%, 90% to 99.5%, 90% to 99%, 90% to 98%, 90% to 97%, 90% to 96%, 90% to 95%, 90% to 94%, 90% to 93%, 90% to 92%, 90% to 91%, 91% to 99.999%, 92% to 99.999%, 93% to 99.999%, 94% to 99.999%, 95% to 99.999%, 96% to 99.999%, 97% to 99.999%, 98% to 99.999%, 99% to 99.999%, 99.5% to 99.999%, 99.9% to 99.999%, 99.95% to 99.999%, 99.99% to 99.999%, or 99.995% to 99.999%, as measured by GC-MS.

In some embodiments, the purity of the reaction product is measured by gas chromatography-flame ionization detection (GC-FID). In some embodiments, the GC-FID is conducted using a DB-5 ms, 30 m×320 μm×0.25 μm column, with a column flow of 2.2 mL/min, a temperature gradient of 90° C. to 300° C., a detection temperature of 300° C., and an air flow rate of 400 mL/min. In some embodiments, the reaction product has a purity of 91% or greater, 92% or greater, 93% or greater, 94% or greater, 95% or greater, 96% or greater, 97% or greater, 98% or greater, 99% or greater, 99.9% or greater, or 99.99% or greater, as measured by GC-FID. In some embodiments, the reaction product has a purity of 90% to 99.999%, or any range or subrange between 90% to 99.999%, as measured by GC-FID. In some embodiments, the reaction product has a purity of 90% to 99.995%, 90% to 99.99%, 90% to 99.95%, 90% to 99.9%, 90% to 99.5%, 90% to 99%, 90% to 98%, 90% to 97%, 90% to 96%, 90% to 95%, 90% to 94%, 90% to 93%, 90% to 92%, 90% to 91%, 91% to 99.999%, 92% to 99.999%, 93% to 99.999%, 94% to 99.999%, 95% to 99.999%, 96% to 99.999%, 97% to 99.999%, 98% to 99.999%, 99% to 99.999%, 99.5% to 99.999%, 99.9% to 99.999%, 99.95% to 99.999%, 99.99% to 99.999%, or 99.995% to 99.999%, as measured by GC-FID.

In some embodiments, the reaction product comprises less than 100 ppm by weight of an alkali metal. In some embodiments, the alkali metal is lithium. In some embodiments, the alkali metal is sodium. In some embodiments, the alkali metal is potassium. In some embodiments, the reaction product comprises less than 10 ppm, less than 1 ppm, less than 100 ppb, less than 10 ppb, less than 1 ppb, less than 100 ppt, less than 10 ppt, or less than 1 ppt by weight of an alkali metal. In some embodiments, the reaction product comprises 0 to 100 ppm, or any range or subrange between 0 to 100ppm, by weight of a halide. In some embodiments, the reaction product comprises 0 to 10 ppm, 0 to 1 ppm, 0 to 100 ppb, 0 to 10 ppb, 0 to 1 ppb, 0 to 100 ppt, 0 to 10 ppt, 0 to 1 ppt, 1 ppt to 100 ppm, 10 ppt to 100 ppm, 100 ppt to 100 ppm, 1 ppb to 100 ppm, 10 ppb to 100 ppm, 100 ppb to 100 ppm, 1 ppm to 100 ppm, or 10 ppm to 100 ppm by weight of an alkali metal. In some embodiments, the reaction product does not comprise any alkali metal. In some embodiments, the reaction product does not comprise any detectable amount of alkali metal. In some embodiments, the detection limit is determined by the equipment being used and the conditions under which the sample is analyzed. In some embodiments, the amount of trace metals, including alkali metals, present in the reaction product is measured using inductively coupled plasma mass spectrometry (ICP-MS).

In some embodiments, the reaction product comprises the compound of the formula:

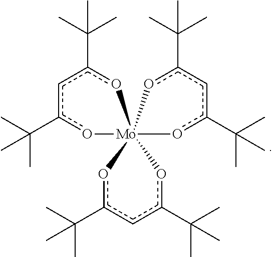

In some embodiments, the reaction product comprises the compound of the formula:

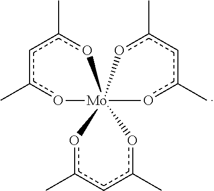

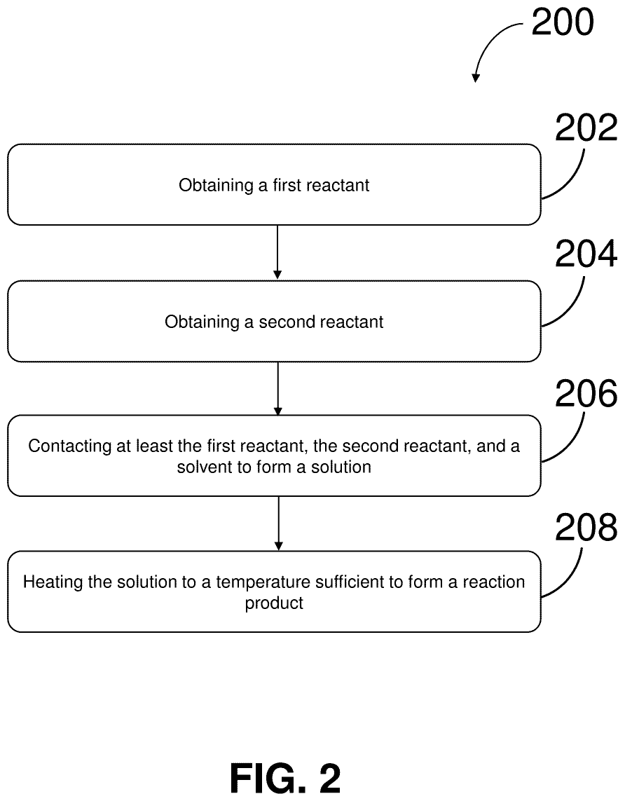

FIG. 2 is a flowchart of a method for forming a reaction product 200, according to some embodiments. As shown in FIG. 2, the method for forming a reaction product 200 may comprise one or more of the following steps: obtaining 202 a first reactant, obtaining 204 a second reactant, contacting 206 at least the first reactant, the second reactant, and a solvent to form a solution, and heating 208 the solution to temperature sufficient to form a reaction product.

At step 202, in some embodiments, the method comprises obtaining a first reactant. In some embodiments, the first reactant comprises a compound of the formula M′ₑMX_{f},
where:
M comprises at least one of a chromium, a molybdenum, a tungsten, or any
combination thereof;
M′ comprises at least one of an alkali metal, an alkali earth metal, an
ammonium ion, or any combination thereof;
e is 1 to 21;
X comprises a halide; and
f is 1 to 24.

In some embodiments, M comprises a chromium. In some embodiments, M comprises a molybdenum. In some embodiments, M comprises a tungsten.

In some embodiments, M′ comprises at least one of an alkali metal, an alkali earth metal, an ammonium ion, or any combination thereof. In some embodiments, the alkali metal comprises a lithium, a sodium, a potassium, a rubidium, a cesium, a francium, or any combination thereof. In some embodiments, the alkali earth metal comprises a beryllium, a magnesium, a calcium, a strontium, a barium, a radium, or any combination thereof. In some embodiments, M′ comprises a lithium. In some embodiments, M′ comprises a sodium. In some embodiments, M′ comprises a potassium. In some embodiments, M′ comprises a rubidium. In some embodiments, M′ comprises a cesium. In some embodiments, M′ comprises a francium. In some embodiments, M′ comprises a beryllium. In some embodiments, M′ comprises a magnesium. In some embodiments, M′ comprises a calcium. In some embodiments, M′ comprises a strontium. In some embodiments, M′ comprises a barium. In some embodiments, M′ comprises a radium. In some embodiments, M′ comprises an ammonium ion.

In some embodiments, e is 1 to 21, or any range or subrange between 1 to 21. In some embodiments, e is 1 to 20, 1 to 19, 1 to 18, 1 to 17, 1 to 16, 1 to 15, 1 to 14, 1 to 13, 1 to 12, 1 to 11, 1 to 10, 1 to 9, 1 to 8, 1 to 7, 1 to 6, 1 to 5, 1 to 4, 1 to 3, 1 to 2, 2 to 21, 3 to 21, 4 to 21, 5 to 21, 6 to 21, 7 to 21, 8 to 21, 9 to 21, 10 to 21, 11 to 21, 12 to 21, 13 to 21, 14 to 21, 15 to 21, 16 to 21, 17 to 21, 18 to 21, 19 to 21, or 20 to 21.

In some embodiments, X comprises a halide. In some embodiments, X comprises a chlorine. In some embodiments, X comprises a fluoride. In some embodiments, X comprises a bromide. In some embodiments, X comprises an iodide.

In some embodiments, f is 1 to 24, or any range or subrange between 1 to 24. In some embodiments, f is 1 to 23, 1 to 22, 1 to 21, 1 to 20, 1 to 19, 1 to 18, 1 to 17, 1 to 16, 1 to 15, 1 to 14, 1 to 13, 1 to 12, 1 to 11, 1 to 10, 1 to 9, 1 to 8, 1 to 7, 1 to 6, 1 to 5, 1 to 4, 1 to 3, 1 to 2, 2 to 24, 3 to 24, 4 to 24, 5 to 24, 6 to 24, 7 to 24, 8 to 24, 9 to 24, 10 to 24, 11 to 24, 12 to 24, 13 to 24, 14 to 24, 15 to 24, 16 to 24, 17 to 24, 18 to 24, 19 to 24, 20 to 24, 21 to 24, 22 to 24, or 23 to 24.

In some embodiments, the first reactant comprises a compound of the formula: K₃MoCl₆

At step 204, in some embodiments, the method comprises obtaining a second reactant. In some embodiments, the second reactant comprises of the formula:

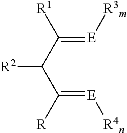

where:
each E independently comprises at least one of an oxygen, a nitrogen, or any combination thereof;
each of R, R¹, R², R³, and R⁴ independently comprises at least one of a hydrogen, an alkyl, a fluoroalkyl, a cycloalkyl, a fluorocycloalkyl, or any combination thereof;
m is 0 or 1; and
n is 0 or 1.

In some embodiments, each E independently comprises at least one of an oxygen, a nitrogen, or any combination thereof. In some embodiments, each E is different. In some embodiments, each E is the same. In some embodiments, each E is oxygen. In some embodiments, each E is nitrogen. In some embodiments, one E is oxygen and the other E is nitrogen.

In some embodiments, each of R, R¹, R², R³, and R⁴ independently comprises at least one of a hydrogen, an alkyl, a fluoroalkyl, a cycloalkyl, a fluorocycloalkyl, or any combination thereof. In some embodiments, each of R, R¹, R², R³, and R⁴ are different. In some embodiments, each of R, R¹, R², R³, and R⁴ are the same. In some embodiments, at least two of R, R¹, R², R³, and R⁴ are the same. In some embodiments, at least two of R, R¹, R², R³, and R⁴ are different. In some embodiments, at least three of R, R¹, R², R³, and R⁴ are the same. In some embodiments, at least three of R, R¹, R², R³, and R⁴ are different. In some embodiments, at least four of R, R¹, R², R³, and R⁴ are the same. In some embodiments, at least four of R, R¹, R², R³, and R⁴ are different.

In some embodiments, m is 0 or 1. In some embodiments, m is 0. In some embodiments, m is 1.

In some embodiments, n is 0 or 1. In some embodiments, n is 0. In some embodiments, n is 1.

In some embodiments, m and n are the same. In some embodiments, m and n are different.

In some embodiments, the second reactant comprises a compound of the formula:

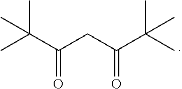

In some embodiments, the second reactant comprises a compound of the formula:

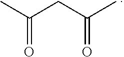

In some embodiments, the obtaining may comprise obtaining a container or other vessel comprising the second reactant.

At step 206, in some embodiments, the method comprises contacting the first reactant, the second reactant, and a solvent to form a solution. In some embodiments, the contacting comprises mixing the first reactant, the second reactant, and the solvent. In some embodiments, the contacting comprises stirring together the first reactant, the second reactant, and the solvent. In some embodiments, the second reactant is provided in excess of the first reactant. In some embodiments, the second reactant is provided in an amount sufficient to fully convert the first reactant to the reaction product. In some embodiments, the second reactant is provided in equal amounts to the first reactant.

In some embodiments, the solvent comprises at least one of at least one of acetic acid, acetone, acetonitrile, benzene, butanol, butanone, t-butyl alcohol, carbon tetrachloride, chlorobenzene, chloroform, cyclohexane, 1,2-dichloroethane, diethylene glycol, diethyl ether, diethylene glycol dimethyl ether, dimethoxyethane, dimethylformamide, dimethyl sulfoxide, 1,4-dioxane, ethanol, ethyl acetate, ethylene glycol, glycerin, heptane, methanol, methyl t-butyl ether, methylene chloride, N-methyl-2-pyrrolidinone, petroleum ether, propanol, pyridine, tetrahydrofuran, triethylamine, water, xylene, any isomer thereof, or any combination thereof.

In some embodiments, the solution comprises at least one of reductant, an oxidant, or any combination thereof. In some embodiments, when the M of the first reactant has an oxidation state of more than 3, the solution comprises a reductant. In some embodiments, the reductant can comprise any reducing agent that acts to reduce the oxidation state of the M in the first reactant. In some embodiments, when the M of the first reactant has an oxidation state of less than 3, the solution comprises an oxidant. In some embodiments, the oxidant can comprise any oxidizing agent that acts to increase the oxidation state of the M in the first reactant.

At step 208, in some embodiments, the method comprises heating the solution to a temperature sufficient to form a reaction product. In some embodiments, the heating comprises heating to a temperature of 50° C. to 250° C., or any range or subrange between 50° C. to 250° C. In some embodiments, the heating comprises heating to a temperature of 50° C. to 240° C., 50° C. to 230° C., 50° C. to 220° C., 50° C. to 210° C., 50° C. to 200° C., 50° C. to 190° C., 50° C. to 180° C., 50° C. to 170° C., 50° C. to 160° C., 50° C. to 150° C., 50° C. to 140° C., 50° C. to 130° C., 50° C. to 120° C., 50° C. to 110° C., 50° C. to 100° C., 50° C. to 90° C., 50° C. to 80° C., 50° C. to 70° C., 50° C. to 60° C., 60° C. to 250° C., 70° C. to 250° C., 80° C. to 250° C., 90° C. to 250° C., 100° C. to 250° C., 110° C. to 250° C., 120° C. to 250° C., 130° C. to 250° C., 140° C. to 250° C., 150° C. to 250° C., 160° C. to 250° C., 170° C. to 250° C., 180° C. to 250° C., 190° C. to 250° C., 200° C. to 250° C., 210° C. to 250° C., 220° C. to 250° C., 230° C. to 250° C., or 240° C. to 250° C.

In some embodiments, the heating comprises heating the solution for a time period of 30 minutes to 48 hours, or any range or subrange between 30 minutes to 48 hours. In some embodiments, the heating comprises heating the solution for a time period of 30 minutes to 46 hours, 30 minutes to 44 hours, 30 minutes to 42 hours, 30 minutes to 40 hours, 30 minutes to 38 hours, 30 minutes to 36 hours, 30 minutes to 34 hours, 30 minutes to 32 hours, 30 minutes to 30 hours, 30 minutes to 28 hours, 30 minutes to 26 hours, 30 minutes to 24 hours, 30 minutes to 22 hours, 30 minutes to 20 hours, 30 minutes to 18 hours, 30 minutes to 16 hours, 30 minutes to 14 hours, 30 minutes to 12 hours, 30 minutes to 10 hours, 30 minutes to 8 hours, 30 minutes to 6 hours, 30 minutes to 4 hours, 30 minutes to 2 hours, 30 minutes to 1 hour, 1 hour to 48 hours, 2 hours to 48 hours, 4 hours to 48 hours, 6 hours to 48 hours, 8 hours to 48 hours, 10 hours to 48 hours, 12 hours to 48 hours, 14 hours to 48 hours, 16 hours to 48 hours, 18 hours to 48 hours, 20 hours to 48 hours, 22 hours to 48 hours, 24 hours to 48 hours, 26 hours to 48 hours, 28 hours to 48 hours, 30 hours to 48 hours, 32 hours to 48 hours, 34 hours to 48 hours, 36 hours to 48 hours, 38 hours to 48 hours, 40 hours to 48 hours, 42 hours to 48 hours, 44 hours to 48 hours, or 46 hours to 48 hours.

In some embodiments, the reaction product comprises a compound of the formula:

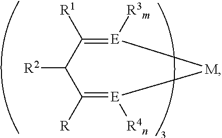

where M, E, R, R¹, R², R³, R⁴, m, and n are as defined above.

In some embodiments, the reaction product has a purity of 90% or greater as measured by gas chromatography-mass spectrometry (GC-MS). In some embodiments, the reaction product has a purity of 90% to 99.999%, or any range or subrange between 90% to 99.999%, as measured by GC-MS. In some embodiments, the reaction product has a purity of 90% to 99.995%, 90% to 99.99%, 90% to 99.95%, 90% to 99.9%, 90% to 99.5%, 90% to 99%, 90% to 98%, 90% to 97%, 90% to 96%, 90% to 95%, 90% to 94%, 90% to 93%, 90% to 92%, 90% to 91%, 91% to 99.999%, 92% to 99.999%, 93% to 99.999%, 94% to 99.999%, 95% to 99.999%, 96% to 99.999%, 97% to 99.999%, 98% to 99.999%, 99% to 99.999%, 99.5% to 99.999%, 99.9% to 99.999%, 99.95% to 99.999%, 99.99% to 99.999%, or 99.995% to 99.999%.

In some embodiments, the purity of the reaction product is measured by gas chromatography-flame ionization detection (GC-FID). In some embodiments, the GC-FID is conducted using a DB-5 ms, 30 m×320 μm×0.25 μm column, with a column flow of 2.2 mL/min, a temperature gradient of 90° C. to 300° C., a detection temperature of 300° C., and an air flow rate of 400 mL/min. In some embodiments, the reaction product has a purity of 91% or greater, 92% or greater, 93% or greater, 94% or greater, 95% or greater, 96% or greater, 97% or greater, 98% or greater, 99% or greater, 99.9% or greater, or 99.99% or greater, as measured by GC-FID. In some embodiments, the reaction product has a purity of 90% to 99.999%, or any range or subrange between 90% to 99.999%, as measured by GC-FID. In some embodiments, the reaction product has a purity of 90% to 99.995%, 90% to 99.99%, 90% to 99.95%, 90% to 99.9%, 90% to 99.5%, 90% to 99%, 90% to 98%, 90% to 97%, 90% to 96%, 90% to 95%, 90% to 94%, 90% to 93%, 90% to 92%, 90% to 91%, 91% to 99.999%, 92% to 99.999%, 93% to 99.999%, 94% to 99.999%, 95% to 99.999%, 96% to 99.999%, 97% to 99.999%, 98% to 99.999%, 99% to 99.999%, 99.5% to 99.999%, 99.9% to 99.999%, 99.95% to 99.999%, 99.99% to 99.999%, or 99.995% to 99.999%, as measured by GC-FID.

In some embodiments, the reaction product comprises less than 100 ppm by weight of an alkali metal. In some embodiments, the alkali metal is lithium. In some embodiments, the alkali metal is sodium. In some embodiments, the alkali metal is potassium. In some embodiments, the reaction product comprises less than 10 ppm, less than 1 ppm, less than 100 ppb, less than 10 ppb, less than 1 ppb, less than 100 ppt, less than 10 ppt, or less than 1 ppt by weight of an alkali metal. In some embodiments, the reaction product comprises 0 to 100 ppm, or any range or subrange between 0 to 100ppm, by weight of a halide. In some embodiments, the reaction product comprises 0 to 10 ppm, 0 to 1 ppm, 0 to 100 ppb, 0 to 10 ppb, 0 to 1 ppb, 0 to 100 ppt, 0 to 10 ppt, 0 to 1 ppt, 1 ppt to 100 ppm, 10 ppt to 100 ppm, 100 ppt to 100 ppm, 1 ppb to 100 ppm, 10 ppb to 100 ppm, 100 ppb to 100 ppm, 1 ppm to 100 ppm, or 10 ppm to 100 ppm by weight of an alkali metal. In some embodiments, the reaction product does not comprise any alkali metal. In some embodiments, the reaction product does not comprise any detectable amount of alkali metal. In some embodiments, the detection limit is determined by the equipment being used and the conditions under which the sample is analyzed. In some embodiments, the amount of trace metals, including alkali metals, present in the reaction product is measured by ICP-MS.

In some embodiments, the reaction product comprises the compound of the formula:

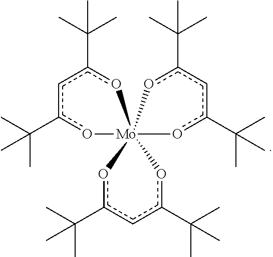

In some embodiments, the reaction product comprises the compound of the formula:

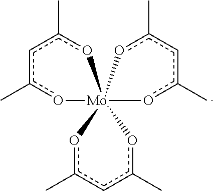

Some embodiments relate to a composition. In some embodiments, the composition comprises a precursor of the formula:

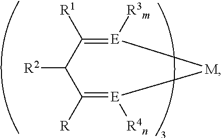

where:
M comprises at least one of a chromium, a molybdenum, a tungsten, or any combination thereof;
each E independently comprises at least one of an oxygen, a nitrogen, or any combination thereof;
each of R, R¹, R³, and R⁴ independently comprises at least one of a hydrogen, an alkyl, a cycloalkyl, a fluoroalkyl, or any combination thereof;
R² comprises at least one of an alkyl, a cycloalkyl, a fluoroalkyl, or any combination thereof;
m is 0 or 1; and
n is 0 or 1.

In some embodiments, M comprises a chromium. In some embodiments, M comprises a molybdenum. In some embodiments, M comprises a tungsten.

In some embodiments, each E independently comprises at least one of an oxygen, a nitrogen, or any combination thereof. In some embodiments, each E is the same. In some embodiments, each E is different. In some embodiments, each E comprises an oxygen. In some embodiments, each E comprises a nitrogen. In some embodiments, one E comprises an oxygen and the other E comprises a nitrogen.

In some embodiments, each of R, R¹, R³, and R⁴ independently comprises at least one of a hydrogen, an alkyl, a cycloalkyl, a fluoroalkyl, or any combination thereof. In some embodiments, each of R, R¹, R³, and R⁴ are the same. In some embodiments, each of R, R¹, R³, and R⁴ are different. In some embodiments, at least two of R, R¹, R³, and R⁴ are the same. In some embodiments, at least two of R, R¹, R³, and R⁴ are different. In some embodiments, at least three of R, R¹, R³, and R⁴ are the same. In some embodiments, at least three of R, R¹, R³, and R⁴ are different. In some embodiments, R and R¹ are the same. In some embodiments, R and R¹ are different. In some embodiments, R and R¹ are methyl. In some embodiments, R and R¹ are isobutyl. In some embodiments, R³ and R⁴ are the same. In some embodiments, R³ and R⁴ are different.

In some embodiments, R² comprises at least one of an alkyl, a cycloalkyl, a fluoroalkyl, or any combination thereof. In some embodiments, R² does not comprise a hydrogen. In some embodiments, R² comprises an alkyl. In some embodiments, R² comprises a cycloalkyl. In some embodiments, R² comprises a fluoroalkyl.

In some embodiments, m is 0 or 1. In some embodiments, m is 0. In some embodiments, m is 1.

In some embodiments, n is 0 or 1. In some embodiments, n is 0. In some embodiments, n is 1.

In some embodiments, m and n are the same. In some embodiments, m and n are different.

In some embodiments, the composition comprises at least 98 mol % of the precursor based on a total moles of the composition as measured by GC-MS. In some embodiments, the composition comprises 98 mol % to 99.999 mol %, or any range or subrange between 98 mol % to 99.999 mol %, of the precursor based on a total moles of the composition as measured by GC-MS. In some embodiments, the composition comprises 98 mol % to 99.995 mol %, 98 mol % to 99.99 mol %, 98 mol % to 99.95 mol %, 98 mol % to 99.9 mol %, 98 mol % to 99.5 mol %, 98 mol % to 99 mol %, 98 mol % to 98.5 mol %, 98.5 mol % to 99.999 mol %, 99 mol % to 99.999 mol %, 99.5 mol % to 99.999 mol %, 99.9 mol % to 99.999 mol %, 99.95 mol % to 99.999 mol %, 99.99 mol % to 99.999 mol %, or 99.995 mol % to 99.999 mol %.

In some embodiments, the mole percentages of the composition are measured using GC-FID, as disclosed herein.

In some embodiments, the composition comprises less than 100 parts per million (ppm) by weight of a halide. In some embodiments, the composition comprises less than 10 ppm, less than 1 ppm, less than 100 parts per billion (ppb), less than 10 ppb, less than 1 ppb, less than 100 parts per trillion (ppt), less than 10 ppt, or less than 1 ppt. In some embodiments, the composition comprises 0 to 100 ppm, or any range or subrange between 0 to 100 ppm, by weight of a halide. In some embodiments, the composition comprises 0 to 10 ppm, 0 to 1 ppm, 0 to 100 ppb, 0 to 10 ppb, 0 to 1 ppb, 0 to 100 ppt, 0 to 10 ppt, 0 to 1 ppt, 1 ppt to 100 ppm, 10 ppt to 100 ppm, 100 ppt to 100 ppm, 1 ppb to 100 ppm, 10 ppb to 100 ppm, 100 ppb to 100 ppm, 1 ppm to 100 ppm, or 10 ppm to 100 ppm by weight of a halide.

In some embodiments, the composition comprises less than 100 ppm by weight of an alkali metal. In some embodiments, the alkali metal is lithium. In some embodiments, the alkali metal is sodium. In some embodiments, the alkali metal is potassium. In some embodiments, the composition comprises less than 10 ppm, less than 1 ppm, less than 100 ppb, less than 10 ppb, less than 1 ppb, less than 100 ppt, less than 10 ppt, or less than 1 ppt by weight of an alkali metal. In some embodiments, the composition comprises 0 to 100 ppm, or any range or subrange between 0 to 100 ppm, by weight of a halide. In some embodiments, the composition comprises 0 to 10 ppm, 0 to 1 ppm, 0 to 100 ppb, 0 to 10 ppb, 0 to 1 ppb, 0 to 100 ppt, 0 to 10 ppt, 0 to 1 ppt, 1 ppt to 100 ppm, 10 ppt to 100 ppm, 100 ppt to 100 ppm, 1 ppb to 100 ppm, 10 ppb to 100 ppm, 100 ppb to 100 ppm, 1 ppm to 100 ppm, or 10 ppm to 100 ppm by weight of an alkali metal. In some embodiments, the composition does not comprise any alkali metal. In some embodiments, the composition does not comprise any detectable amount of alkali metal. In some embodiments, the detection limit is determined by the equipment being used and the conditions under which the sample is analyzed. In some embodiments, the amount of trace metals, including alkali metals, present in the composition is measured using ICP-MS.

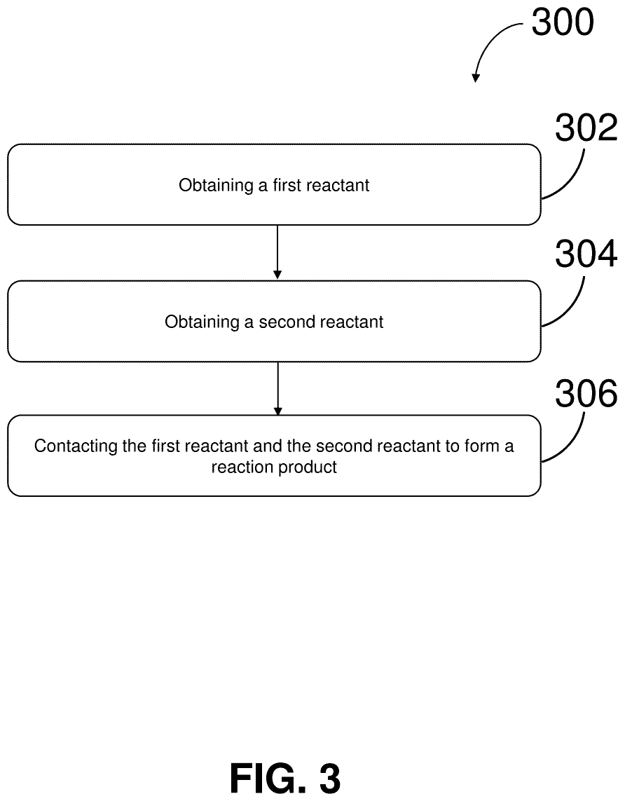

FIG. 3 is a flowchart of a method for forming a reaction product 300, according to some embodiments. As shown in FIG. 3, the method for forming a reaction product 300 may comprise one or more of the following steps: obtaining 302 a first reactant, obtaining 304 a second reactant, and contacting 306 the first reactant and the second reactant to form a reaction product.

At step 302, in some embodiments, the method comprises obtaining a first reactant. In some embodiments, the first reactant comprises a compound of the formula:

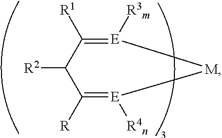

where:
M comprises at least one of a chromium, a molybdenum, a tungsten, or any combination thereof;
each E independently comprises at least one of an oxygen, a nitrogen, or any combination thereof;
each of R, R¹, R², R³, and R⁴ independently comprises at least one of a hydrogen, an alkyl, a fluoroalkyl, a cycloalkyl, a fluorocycloalkyl, or any combination thereof;
m is 0 or 1; and
n is 0 or 1.

In some embodiments, each E independently comprises at least one of an oxygen, a nitrogen, or any combination thereof. In some embodiments, each E is different. In some embodiments, each E is the same. In some embodiments, each E is oxygen. In some embodiments, each E is nitrogen. In some embodiments, one E is oxygen and the other E is nitrogen.

In some embodiments, each of R, R¹, R², R³, and R⁴ independently comprises at least one of a hydrogen, an alkyl, a fluoroalkyl, a cycloalkyl, a fluorocycloalkyl, or any combination thereof. In some embodiments, each of R, R¹, R², R³, and R⁴ are different. In some embodiments, each of R, R¹, R², R³, and R⁴ are the same. In some embodiments, at least two of R, R¹, R², R³, and R⁴ are the same. In some embodiments, at least two of R, R¹, R², R³, and R⁴ are different. In some embodiments, at least three of R, R¹, R², R³, and R⁴ are the same. In some embodiments, at least three of R, R¹, R², R³, and R⁴ are different. In some embodiments, at least four of R, R¹, R², R³, and R⁴ are the same. In some embodiments, at least four of R, R¹, R², R³, and R⁴ are different.

In some embodiments, m is 0 or 1. In some embodiments, m is 0. In some embodiments, m is 1.

In some embodiments, n is 0 or 1. In some embodiments, n is 0. In some embodiments, n is 1.

In some embodiments, m and n are the same. In some embodiments, m and n are different.

At step 304, in some embodiments, the method comprises obtaining a second reactant. In some embodiments, the second reactant comprises of the formula:

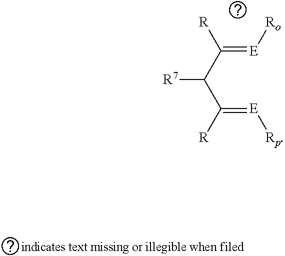

where:
each E independently comprises at least one of an oxygen, a nitrogen, or any combination thereof;
each of R⁵, R⁶, R⁷, R⁸, and R⁹ independently comprises at least one of a hydrogen, an alkyl, a fluoroalkyl, a cycloalkyl, a fluorocycloalkyl, or any combination thereof;
o is 0 or 1; and
p is 0 or 1.

In some embodiments, each E independently comprises at least one of an oxygen, a nitrogen, or any combination thereof. In some embodiments, each E is different. In some embodiments, each E is the same. In some embodiments, each E is oxygen. In some embodiments, each E is nitrogen. In some embodiments, one E is oxygen and the other E is nitrogen.

In some embodiments, each of R⁵, R⁶, R⁷, R⁸, and R⁹ independently comprises at least one of a hydrogen, an alkyl, a fluoroalkyl, a cycloalkyl, a fluorocycloalkyl, or any combination thereof. In some embodiments, each of R⁵, R⁶, R⁷, R⁸, and R⁹ are different. In some embodiments, each of R⁵, R⁶, R⁷, R⁸, and R⁹ are the same. In some embodiments, at least two of R⁵, R⁶, R⁷, R⁸, and R⁹ are the same. In some embodiments, at least two of R⁵, R⁶, R⁷, R⁸, and R⁹ are different. In some embodiments, at least three of R⁵, R⁶, R⁷, R⁸, and R⁹ are the same. In some embodiments, at least three of R⁵, R⁶, R⁷, R⁸, and R⁹ are different. In some embodiments, at least four of of R⁵, R⁶, R⁷, R⁸, and R⁹ are the same. In some embodiments, at least four of of R⁵, R⁶, R⁷, R⁸, and Ro are different.

In some embodiments, o is 0 or 1. In some embodiments, o is 0. In some embodiments, o is 1.

In some embodiments, p is 0 or 1. In some embodiments, p is 0. In some embodiments, p is 1.

In some embodiments, o and p are the same. In some embodiments, o and p are different.

In some embodiments, the obtaining may comprise obtaining a container or other vessel comprising the second reactant.

At step 306, in some embodiments, the method comprises contacting the first reactant and the second reactant to form a reaction product. In some embodiments, the second reactant is provided in excess of the first reactant. In some embodiments, the second reactant is provided in an amount sufficient to fully convert the first reactant to the reaction product. In some embodiments, the second reactant is provided in equal amounts to the first reactant. In some embodiments, the method does comprise the use of a solvent. In some embodiments, the contacting comprises mixing the first reactant and the second reactant. In some embodiments, the contacting comprises stirring the first reactant and second reactant together.

In some embodiments, the contacting comprises heating the first reactant and second reactant to form the reaction product. In some embodiments, the heating comprises heating to a temperature of 50° C. to 250° C., or any range or subrange between 50° C. to 250° C. In some embodiments, the heating comprises heating to a temperature of 50° C. to 240° C., 50° C. to 230° C., 50° C. to 220° C., 50° C. to 210° C., 50° C. to 200° C., 50° C. to 190° C., 50° C. to 180° C., 50° C. to 170° C., 50° C. to 160° C., 50° C. to 150° C., 50° C. to 140° C., 50° C. to 130° C., 50° C. to 120° C., 50° C. to 110° C., 50° C. to 100° C., 50° C. to 90° C., 50° C. to 80° C., 50° C. to 70° C., 50° C. to 60° C., 60° C. to 250° C., 70° C. to 250° C., 80° C. to 250° C., 90° C. to 250° C., 100° C. to 250° C., 110° C. to 250° C., 120° C. to 250° C., 130° C. to 250° C., 140° C. to 250° C., 150° C. to 250° C., 160° C. to 250° C., 170° C. to 250° C., 180° C. to 250° C., 190° C. to 250° C., 200° C. to 250° C., 210° C. to 250° C., 220° C. to 250° C., 230° C. to 250° C., or 240° C. to 250° C.

In some embodiments, the contact comprises contacting the first reactant and the second reactant for a time period of 30 minutes to 48 hours, or any range or subrange between 30 minutes to 48 hours. In some embodiments, the contacting comprises contacting the first reactant and the second reactant for a time period of 30 minutes to 46 hours, 30 minutes to 44 hours, 30 minutes to 42 hours, 30 minutes to 40 hours, 30 minutes to 38 hours, 30 minutes to 36 hours, 30 minutes to 34 hours, 30 minutes to 32 hours, 30 minutes to 30 hours, 30 minutes to 28 hours, 30 minutes to 26 hours, 30 minutes to 24 hours, 30 minutes to 22 hours, 30 minutes to 20 hours, 30 minutes to 18 hours, 30 minutes to 16 hours, 30 minutes to 14 hours, 30 minutes to 12 hours, 30 minutes to 10 hours, 30 minutes to 8 hours, 30 minutes to 6 hours, 30 minutes to 4 hours, 30 minutes to 2 hours, 30 minutes to 1 hour, 1 hour to 48 hours, 2 hours to 48 hours, 4 hours to 48 hours, 6 hours to 48 hours, 8 hours to 48 hours, 10 hours to 48 hours, 12 hours to 48 hours, 14 hours to 48 hours, 16 hours to 48 hours, 18 hours to 48 hours, 20 hours to 48 hours, 22 hours to 48 hours, 24 hours to 48 hours, 26 hours to 48 hours, 28 hours to 48 hours, 30 hours to 48 hours, 32 hours to 48 hours, 34 hours to 48 hours, 36 hours to 48 hours, 38 hours to 48 hours, 40 hours to 48 hours, 42 hours to 48 hours, 44 hours to 48 hours, or 46 hours to 48 hours.

In some embodiments, the contacting comprises combining the first reactant and the second reactant under vacuum.

In some embodiments, the reaction product comprises a compound of the formula:

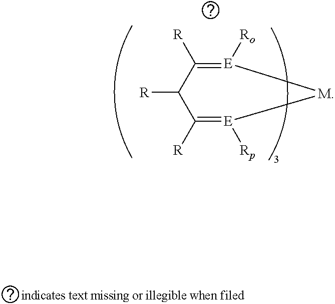

where M, E, R⁵, R⁶, R⁷, R⁸, R⁹, o, and p are as defined above.

In some embodiments, the reaction product has a purity of 90% or greater as measured by gas chromatography-mass spectrometry (GC-MS). In some embodiments, the reaction product has a purity of 91% or greater, 92% or greater, 93% or greater, 94% or greater, 95% or greater, 96% or greater, 97% or greater, 98% or greater, 99% or greater, 99.9% or greater, or 99.99% or greater, as measured by GC-MS. In some embodiments, the reaction product has a purity of 90% to 99.999%, or any range or subrange between 90% to 99.999%, as measured by GC-MS. In some embodiments, the reaction product has a purity of 90% to 99.995%, 90% to 99.99%, 90% to 99.95%, 90% to 99.9%, 90% to 99.5%, 90% to 99%, 90% to 98%, 90% to 97%, 90% to 96%, 90% to 95%, 90% to 94%, 90% to 93%, 90% to 92%, 90% to 91%, 91% to 99.999%, 92% to 99.999%, 93% to 99.999%, 94% to 99.999%, 95% to 99.999%, 96% to 99.999%, 97% to 99.999%, 98% to 99.999%, 99% to 99.999%, 99.5% to 99.999%, 99.9% to 99.999%, 99.95% to 99.999%, 99.99% to 99.999%, or 99.995% to 99.999%.

In some embodiments, the purity of the reaction product is measured using GC-FID, as disclosed herein.

In some embodiments, the reaction product comprises less than 100 ppm by weight of an alkali metal. In some embodiments, the alkali metal is lithium. In some embodiments, the alkali metal is sodium. In some embodiments, the alkali metal is potassium. In some embodiments, the reaction product comprises less than 10 ppm, less than 1 ppm, less than 100 ppb, less than 10 ppb, less than 1 ppb, less than 100 ppt, less than 10 ppt, or less than 1 ppt by weight of an alkali metal. In some embodiments, the reaction product comprises 0 to 100 ppm, or any range or subrange between 0 to 100 ppm, by weight of a halide. In some embodiments, the reaction product comprises 0 to 10 ppm, 0 to 1 ppm, 0 to 100 ppb, 0 to 10 ppb, 0 to 1 ppb, 0 to 100 ppt, 0 to 10 ppt, 0 to 1 ppt, 1 ppt to 100 ppm, 10 ppt to 100 ppm, 100 ppt to 100 ppm, 1 ppb to 100 ppm, 10 ppb to 100 ppm, 100 ppb to 100 ppm, 1 ppm to 100 ppm, or 10 ppm to 100 ppm by weight of an alkali metal. In some embodiments, the reaction product does not comprise any alkali metal. In some embodiments, the reaction product does not comprise any detectable amount of alkali metal. In some embodiments, the detection limit is determined by the equipment being used and the conditions under which the sample is analyzed. In some embodiments, the amount of trace metals, including alkali metals, present in the reaction product is measured by ICP-MS.

Any one or more of the embodiments disclosed herein shall be understood to be combinable without departing from the scope or spirit of the disclosure.

### Example 1: Synthesis of Tris(2,2,6,6-Tetramethyl-3,5-heptanedionato) Molybdenum from Mo(CO)6 and 2,2,6,6-Tetramethyl-3,5-heptanedione

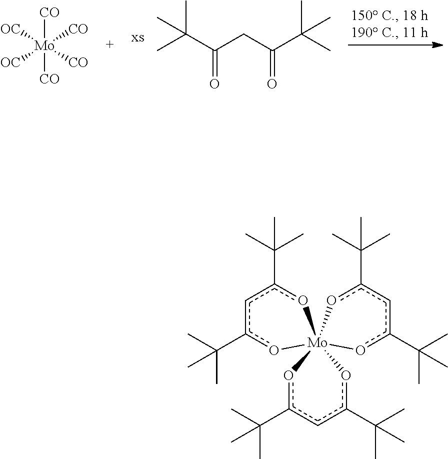

A 500 mL flask was charged with Mo (CO) 6 (30.00 g, 1.000 Eq, 113.6 mmol) and 2,2,6,6-tetramethyl-3,5-heptanedione (209.4 g, 10.00 Eq, 1.136 mol) (HTHD), equipped with an air cooled condenser. The mixture in the flask was heated to about 150° C. for 18 hours. The Mo(CO)₆ that had sublimed on the flask walls was rinsed down by agitating the flask. The heat was then increased to about 190° C. The heating continued for 11 hours with periodic rinsing of the flask walls and condenser with the reaction mixture. A brown residue was produced. The excess HTHD was then removed by attaching a distillation adapter to the condenser and pulling off the bulk of the solvent under full vacuum (100 mtorr) with the flask heated in a 200° C. oil bath. When the brown residue was mostly dry, the distillation adapter was attached directly to the flask and the remaining solvent was distilled away while the oil bath temperature was increased to 215° C. The endpoint of the process was observed when the dark brown product sublimed up into the distillation adapter. The brown solid was collected and massed. 70.22 g (95.6%) of crude product was obtained. The crude product was loaded into a sublimation apparatus and sublimed under a 50-100 mtorr vacuum to an ambient temperature coldfinger while being heated in a 175° C. oil bath. A dark brown solid was collected from the coldfinger and massed. 69.12 g (94% yield) of solid was obtained. The solid was measured using NMR and was observed to have the following chemical shifts: ¹H NMR (400 MHz, d₆-benzene, 298 K): δ 46.74 (br s, υ_{1/2}=250 hz), ppm. 13C {¹H} NMR (100 MHz, d₆-benzene, 289 K): δ 277.55 ppm. The molecular purity as determined by GC-MS analysis of a 10 ppm sample in hexanes was greater than 99%. The purity of the product as measured by thermogravimetric analysis (TGA) was greater than 99%.

### Example 2: Synthesis of Tris(2,2,6,6-Tetramethyl-3,5-heptanedionato) Molybdenum from Mo(Acac)₃ and 2,2,6,6-Tetramethyl-3,5-heptanedione

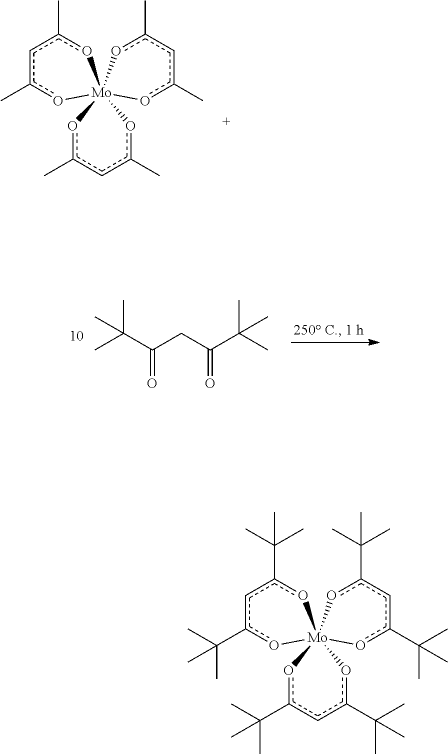

A small scale vacuum distillation apparatus with a 25 mL distillation pot and a 15 mL receiving flask was charged with tris(acetylacetonato)molybdenum (2.00 g, 1.000 Eq, 5.09 mmol) and 2,2,6,6-tetramethyl-3,5-heptanedione (9.37 g, 10.00 Eq, 50.9 mmol) (HTHD). The flask was heated to 190° C. in an oil bath. There was no distillation of any dione at this point, so the temperature was raised to 250° C. and about 10 ml of dione was distilled over to the receiving flask. When the distillation was complete, the distilled dione was characterized by ¹H NMR which indicated that both the acetylacetone and the HTHD ligand were both present. The reaction mixture was then heated to 90° C. and most of the dione was distilled away under reduced pressure leaving a residue. The residue was then heated to 170° C. under full vacuum for 2 hours. The product sublimed to the top of the flask during this time. The temperature was increased to 190° C. to drive off any residual solvent. The sublimed product was then removed from the flask (1.80 g, 76%) and characterized by ¹H NMR which confirmed the identity of the desired product.

### Example 3: Synthesis of Tris(2,2,6,6-Tetramethyl-3,5-heptanedionato) Molybdenum from K₃MoCl₆ and 2,2,6,6-Tetramethyl-3,5-heptanedione

2,2,6,6-tetramethyl-3,5-heptanedione (76.8 g, 0.417 mol) is added to 100 ml of water. The mixture is heated to 50° C. and potassium hexachloromolybdate (17.76 g, 0.0417 mol) is added. The mixture is heated at 50° C. for 18 hours. The solid that is formed is separated by vacuum filtration, washed with water, and dried under vacuum to give tris(2,2,6,6-tetramethyl-3,5-heptanedionato)molybdenum.

### Example 4: Synthesis of Tris(2,2,6,6-Tetramethyl-3,5-heptanedionato) Molybdenum from K₃MoCl₆ and 2,2,6,6-Tetramethyl-3,5-heptanedione

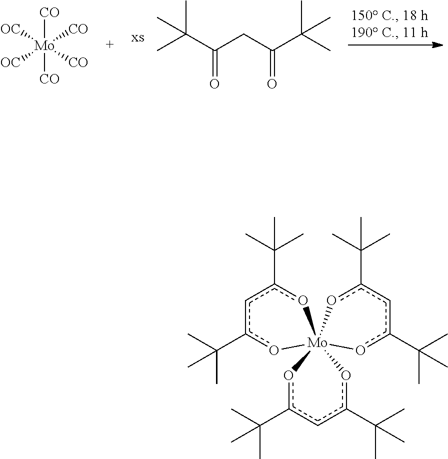

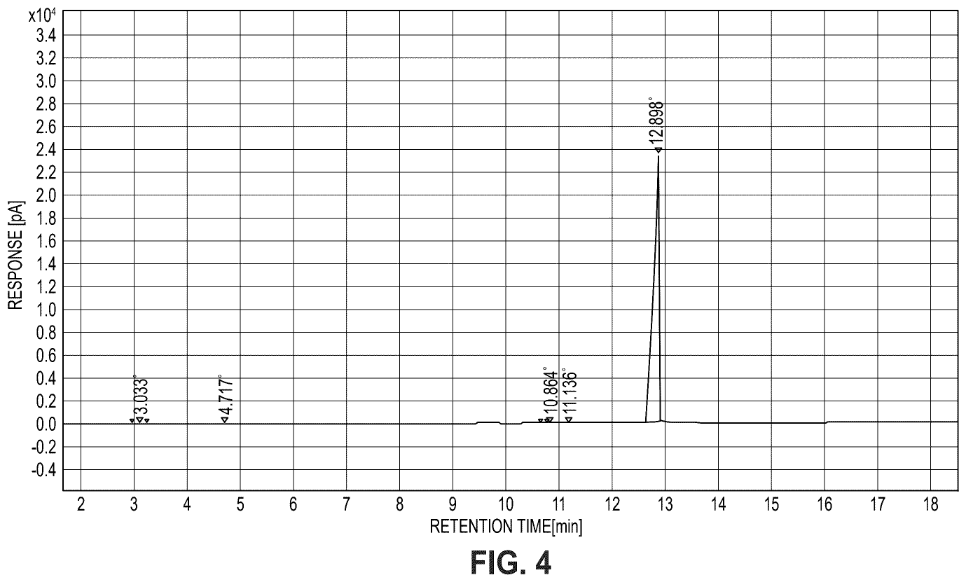

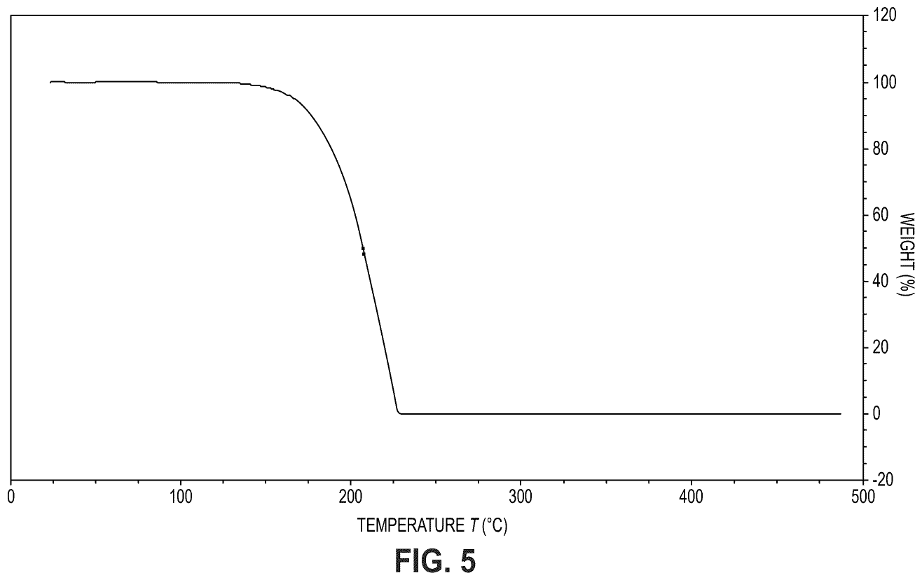

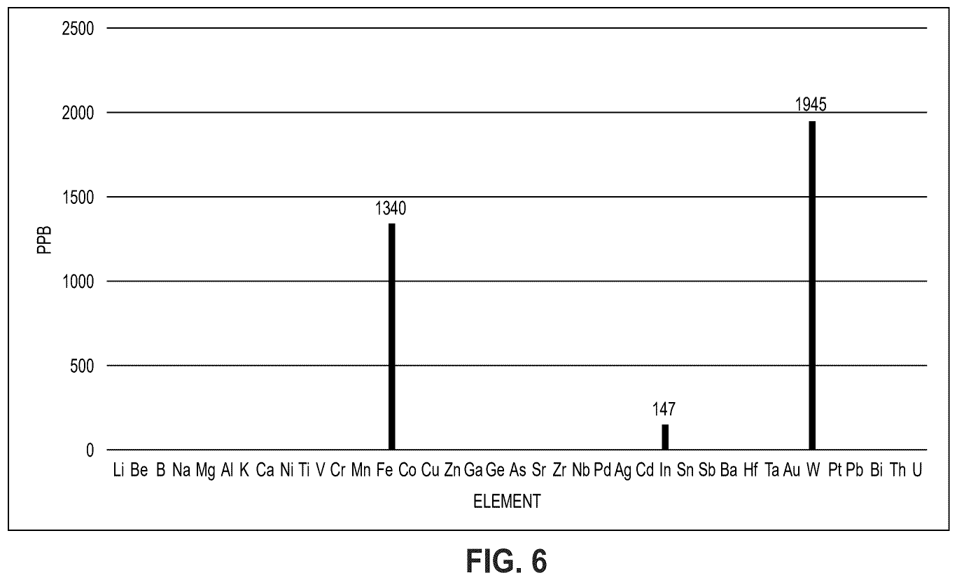

A 2 L, 4 neck flask was charged with Mo(CO)₆ (110.0 g, 1.000 Eq, 416.65 mmol) and 2,2,6,6-tetramethyl-3,5-heptanedione (757.8 g, 10.00 Eq, 4.166 mol) (HTHD). The flask was equipped with a condenser and heated to an internal temperature of 160° C. over 2 hours. The reaction mixture was heated at an internal temperature of about 160° C. for 18 hours. The reaction mixture was heated to an internal temperature of 180° C. for two hours, 190° C. for two hours, and was stopped when the internal temperature reached 195° C. The Mo(CO)₆ that had sublimed on the flask walls was rinsed down by agitating the flask during the heating process. The excess HTHD was distilled away under reduced pressure to a final internal temperature of about 150° C. and a 50 mtorr vacuum. The endpoint of the process was observed when the dark brown product sublimed up into the distillation adapter. The brown solid was sublimed out of the reaction flask via a heat-traced adapter to a 1 L collection flask at a pressure of 50-100 mtorr using an oil bath (165-175° C.) to heat the 2 L crude product containing flask. The dark brown solid product was collected from the 1 L sublimate flask (240.0 g, 90% yield). The solid was measured using NMR and was observed to have the following chemical shifts: ¹H NMR (400 MHz, d₆-benzene, 298 K): δ 46.74 (br s, υ_{1/2}=250 hz), ppm. ¹³C {¹H} NMR (100 MHz, d₆-benzene, 289 K): δ 277.55 ppm. As shown in FIG. 4, the molecular purity as determined by GC-FID analysis of a 100 ppm sample in hexanes was greater than 99.9%. As shown in FIG. 5, the TGA analysis of the product showed about 0.0% residue. As shown in FIG. 6, the trace metals analysis by ICP-MS showed 1340 ppb iron, 147 ppb Indium, and 1945 ppb tungsten with all other elements below the detection limit.

### Aspects

Various Aspects are described below. It is to be understood that any one or more of the features recited in the following Aspect(s) can be combined with any one or more other Aspect(s).

### Aspect 1

A method comprising:
obtaining a first reactant of the formula:

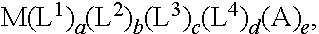

where:
   M comprises at least one of chromium, molybdenum, tungsten, or any combination thereof;
   each of L¹, L², L³, and L⁴ independently comprises at least one of an amine, a carbon monoxide, a carbonyl, a nitrile, an isonitrile, a thioalkyl, a sulfoxide, an ester, an alkoxy, a polyol, an anhydride, a heterocyclic, a phosphine, a guanidino, an amidino, an alkenyl, a cycloalkenyl, an alkynyl, a cycloalkynyl, an aryl, a dinitrogen, an aquo, a nitric oxide, a sulfonyl, or any combination thereof;
   a is 0 to 6;
   b is 0 to 6;
   c is 0 to 6;
   d is 0 to 6;
   A is an anionic type ligand comprising at least one of an alkyl, an allyl, an alkenyl, an alkynyl, a cycloalkyl, a cycloalkenyl, a cycloalkynyl, a haloalkyl, a halocycloalkyl, a hydride, an aryl, a hydrazino, a hydrazido, an imido, a halide, a triflate, a tosylate, a mesylate, an amido, an iminato, an amidinato, a β-diketiminato, β-diketonato, propiolamidinato, amidoximato, hydrazonato, a phosphide, or any combination thereof;
   e is 0 to 6;
   a+b+c+d+e is 1 to 8;
obtaining a second reactant of the formula:

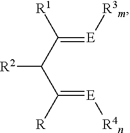

where:
   each E independently comprises at least one of an oxygen, a nitrogen, or any combination thereof;
   each of R, R¹, R², R³, and R⁴ independently comprises at least one of a hydrogen, an alkyl, a fluoroalkyl, a cycloalkyl, a fluorocycloalkyl, or any combination thereof;
   m is 0 or 1;
   n is 0 or 1; and
contacting the first reactant and the second reactant to form a reaction product,
   wherein the reaction product comprises a compound of the formula:

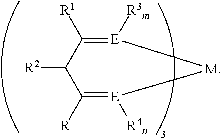

### Aspect 2

The method according to Aspect 1, at least one of L¹, L², L³, L⁴, A, or any combination thereof is a ligand bridging two or more metal centers, M.

### Aspect 3

The method according to any one of Aspects 1-2, wherein the second reactant is provided in excess of the first reactant.

### Aspect 4

The method according to any one of Aspects 1-3, wherein the method does not comprise the use of a solvent.

### Aspect 5

The method according to any one of Aspects 1-4, wherein the reaction product has a purity of 90% or greater as measured by gas chromatography-mass spectroscopy (GC-MS).

### Aspect 6

The method according to any one of Aspects 1-5, wherein the reaction product has a purity of 90% to 99.999% as measured by GC-MS.

### Aspect 7

The method of according to any one of Aspects 1-6, wherein the reaction product comprises less than 10 ppm by weight of an alkali metal.

### Aspect 8

A method comprising:
obtaining a first reactant of the formula:

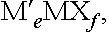

where:
   M comprises at least one of a chromium, a molybdenum, a tungsten, or any combination thereof;
   M′ comprises at least one of an alkali metal, an alkali earth metal, an ammonium ion, or any combination thereof;
   e is 1 to 21;
   X comprises a halide; and
   f is 1 to 24;
obtaining a second reactant of the formula:

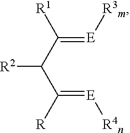

where:
   each E independently comprises at least one of an oxygen, a nitrogen, or any combination thereof;
   each of R, R¹, R², R³, and R⁴ independently comprises at least one of a hydrogen, an alkyl, a fluoroalkyl, a cycloalkyl, a fluorocycloalkyl, or any combination thereof;
   m is 0 or 1;
   n is 0 or 1;
contacting at least the first reactant, the second reactant, and a solvent to form a solution; and
heating the solution to a temperature sufficient to form a reaction product,
   wherein the reaction product comprises a compound of the formula:

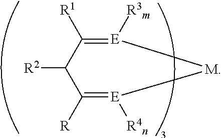

### Aspect 9

The method according to Aspect 8, wherein the solvent comprises a water.

### Aspect 10

The method according to any one of Aspects 8-9, wherein the second reactant is provided in excess to the first reactant.

### Aspect 11

The method according to any one of Aspects 8-10, wherein the solution further comprises a reductant when the M of the first reactant has an oxidation state of more than 3.

### Aspect 12

The method according to any one of Aspects 8-11, wherein the solution further comprises an oxidant when the M of the first reactant has an oxidation state of less than 3.

### Aspect 13

A composition comprising:
a precursor of the formula:

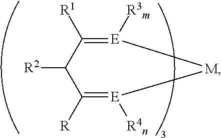

where:
   M comprises at least one of a chromium, a molybdenum, a tungsten, or any combination thereof;
   each E independently comprises at least one of an oxygen, a nitrogen, or any combination thereof;
   each of R, R¹, R³, and R⁴ independently comprises at least one of a hydrogen, an alkyl, a fluoroalkyl, a cycloalkyl, a fluorocycloalkyl, or any combination thereof;
   R² comprises an alkyl, a fluoroalkyl, a cycloalkyl, a fluorocycloalkyl,
   or any combination thereof;
   m is 0 or 1; and
   n is 0 or 1.

### Aspect 14

The composition according to Aspect 13, wherein the composition comprises at least 98 mol % of the precursor based on a total moles of the composition as measured by GC-MS.

### Aspect 15

The composition according to any one of Aspects 13-14, wherein the composition comprises less than 100 ppm by weight of a halide and less than 100 ppm by weight of an alkali metal.

### Aspect 16

The composition according to any one of Aspects 13-15, wherein the composition comprises less than 10 ppm by weight of a halide and less than 10 ppm by weight of an alkali metal.

### Aspect 17

The composition according to any one of Aspects 13-16, wherein R and R¹ are methyl.

### Aspect 18

The composition according to any one of Aspects 13-17, wherein R and R¹ are isobutyl.

### Aspect 19

A method comprising:
obtaining a first reactant of the formula:

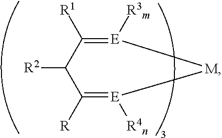

where:
   M comprises at least one of a chromium, a molybdenum, a tungsten, or any combination thereof;
   each E independently comprises at least one of an oxygen, a nitrogen, or any combination thereof;
   each of R, R¹, R², R³, and R⁴ independently comprises at least one of a hydrogen, an alkyl, a fluoroalkyl, a cycloalkyl, a fluorocycloalkyl,
   or any combination thereof;
   m is 0 or 1; and
   n is 0 or 1;
obtaining a second reactant of the formula:

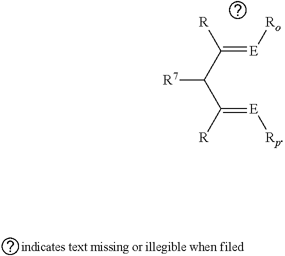

where:
   each E independently comprises at least one of an oxygen, a nitrogen, or any combination thereof;
   each of R⁵, R⁶, R⁷, R⁸, and R⁹ independently comprises at least one of a hydrogen, an alkyl, a fluoroalkyl, a cycloalkyl, a fluorocycloalkyl, or any combination thereof;
   o is 0 or 1;
   p is 0 or 1; and
contacting the first reactant and the second reactant to form a reaction product,
   wherein the reaction product comprises a compound of the formula:

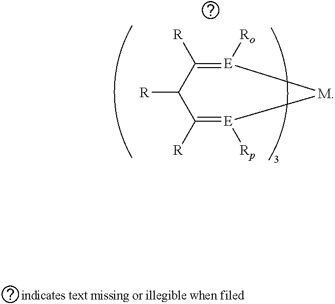

### Aspect 20

The method according to Aspect 19, wherein the contacting comprises heating the first reactant and the second reactant.

### Aspect 21

The method according to any one of Aspects 19-20, wherein the contacting comprises combining the first reactant and the second reactant under vacuum.

### Aspect 22

The method of according to any one of Aspects 19-21, wherein the reaction product comprises less than 10 ppm by weight of an alkali metal.

What is claimed is:

1. A method comprising:
obtaining a first reactant of the formula: 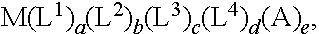
where:
M comprises at least one of chromium, molybdenum, tungsten, or any combination thereof;
each of L¹, L², L³, and L⁴ independently comprises at least one of an amine, a carbon monoxide, a carbonyl, a nitrile, an isonitrile, a thioalkyl, a sulfoxide, an ester, an alkoxy, a polyol, an anhydride, a heterocyclic, a phosphine, a guanidino, an amidino, an alkenyl, a cycloalkenyl, an alkynyl, a cycloalkynyl, an aryl, a dinitrogen, an aquo, a nitric oxide, a sulfonyl, or any combination thereof;
a is 0 to 6;
b is 0 to 6;
c is 0 to 6;
d is 0 to 6;
A is an anionic type ligand comprising at least one of an alkyl, an allyl, an alkenyl, an alkynyl, a cycloalkyl, a cycloalkenyl, a cycloalkynyl, a haloalkyl, a halocycloalkyl, a hydride, an aryl, a hydrazino, a hydrazido, an imido, a halide, a triflate, a tosylate, a mesylate, an amido, an iminato, an amidinato, a β-diketiminato, β-diketonato, propiolamidinato, amidoximato, hydrazonato, a phosphide, or any combination thereof;
e is 0 to 6;
a+b+c+d+e is 1 to 8;
obtaining a second reactant of the formula: 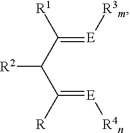
where:
each E independently comprises at least one of an oxygen, a nitrogen, or any combination thereof;
each of R, R¹, R², R³, and R⁴ independently comprises at least one of a hydrogen, an alkyl, a fluoroalkyl, a cycloalkyl, a fluorocycloalkyl, or any combination thereof;
m is 0 or 1;
n is 0 or 1; and
contacting the first reactant and the second reactant to form a reaction product,
wherein the reaction product comprises a compound of the formula:

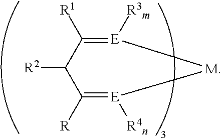

2. The method of claim 1, at least one of L¹, L², L³, L⁴, A, or any combination thereof is a ligand bridging two or more metal centers, M.

3. The method of claim 1, wherein the second reactant is provided in excess of the first reactant.

4. The method of claim 1, wherein the method does not comprise the use of a solvent.

5. The method of claim 1, wherein the reaction product has a purity of 90% or greater as measured by gas chromatography-mass spectroscopy (GC-MS).

6. The method of claim 1, wherein the reaction product has a purity of 90% to 99.999% as measured by GC-MS.

7. The method of claim 1, wherein the reaction product comprises less than 10 ppm by weight of an alkali metal.

8. A method comprising:
obtaining a first reactant of the formula: 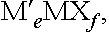
where:
M comprises at least one of a chromium, a molybdenum, a tungsten, or any combination thereof;
M′ comprises at least one of an alkali metal, an alkali earth metal, an ammonium ion, or any combination thereof;
e is 1 to 21;
X comprises a halide; and
f is 1 to 24;
obtaining a second reactant of the formula: 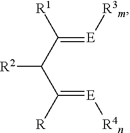
where:
each E independently comprises at least one of an oxygen, a nitrogen, or any combination thereof;
each of R, R¹, R², R³, and R⁴ independently comprises at least one of a hydrogen, an alkyl, a fluoroalkyl, a cycloalkyl, a fluorocycloalkyl, or any combination thereof;
m is 0 or 1;
n is 0 or 1;
contacting at least the first reactant, the second reactant, and a solvent to form a solution; and
heating the solution to a temperature sufficient to form a reaction product,
wherein the reaction product comprises a compound of the formula:

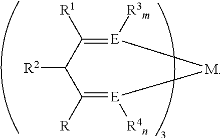

9. The method of claim 8, wherein the solvent comprises a water.

10. The method of claim 8, wherein the second reactant is provided in excess to the first reactant.

11. The method of claim 8, wherein the solution further comprises a reductant when the M of the first reactant has an oxidation state of more than 3.

12. The method of claim 8, wherein the solution further comprises an oxidant when the M of the first reactant has an oxidation state of less than 3.

13. A composition comprising:
a precursor of the formula: 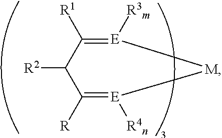
where:
M comprises at least one of a chromium, a molybdenum, a tungsten, or any combination thereof;
each E independently comprises at least one of an oxygen, a nitrogen, or any combination thereof;
each of R, R¹, R³, and R⁴ independently comprises at least one of a hydrogen, an alkyl, a fluoroalkyl, a cycloalkyl, a fluorocycloalkyl, or any combination thereof;
R² comprises an alkyl, a fluoroalkyl, a cycloalkyl, a fluorocycloalkyl, or any combination thereof;
m is 0 or 1; and
n is 0 or 1.

14. The composition of claim 13, wherein the composition comprises at least 98 mol % of the precursor based on a total moles of the composition as measured by GC-MS.

15. The composition of claim 13, wherein the composition comprises less than 100ppm by weight of a halide and less than 100 ppm by weight of an alkali metal.

16. The composition of claim 13, wherein the composition comprises less than 10 ppm by weight of a halide and less than 10 ppm by weight of an alkali metal.

17. The composition of claim 13, wherein R and R¹ are methyl.

18. The composition of claim 13, wherein R and R¹ are isobutyl.

19. A method comprising:
obtaining a first reactant of the formula: 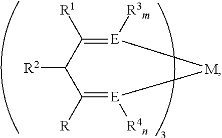
where:
M comprises at least one of a chromium, a molybdenum, a tungsten, or any combination thereof;
each E independently comprises at least one of an oxygen, a nitrogen, or any combination thereof;
each of R, R¹, R², R³, and R⁴ independently comprises at least one of a hydrogen, an alkyl, a fluoroalkyl, a cycloalkyl, a fluorocycloalkyl, or any combination thereof;
m is 0 or 1; and
n is 0 or 1;
obtaining a second reactant of the formula: 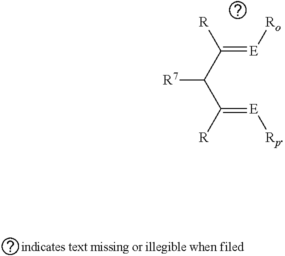
where:
each E independently comprises at least one of an oxygen, a nitrogen, or any combination thereof;
each of R⁵, R⁶, R⁷, R⁸, and R⁹ independently comprises at least one of a hydrogen, an alkyl, a fluoroalkyl, a cycloalkyl, a fluorocycloalkyl, or any combination thereof;
o is 0 or 1;
p is 0 or 1; and
contacting the first reactant and the second reactant to form a reaction product,
wherein the reaction product comprises a compound of the formula:

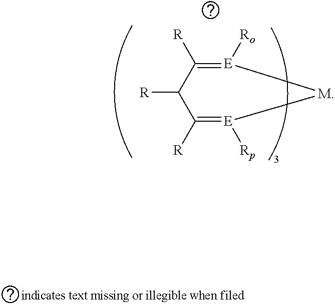

20. The method of claim 19, wherein the contacting comprises combining the first reactant and the second reactant under vacuum.
